(19) United States
(12) Patent Application Publication
(10) Pub. No.: US 2021/0168401 A1
(43) Pub. Date: Jun. 3, 2021

(54) METHOD FOR ENCODING/DECODING IMAGE AND DEVICE THEREOF

(71) Applicant: SAMSUNG ELECTRONICS CO., LTD., Suwon-si (KR)

(72) Inventors: Min-soo PARK, Seoul (KR); Ki-ho CHOI, Seoul (KR)

(73) Assignee: SAMSUNG ELECTRONICS CO., LTD., Suwon-si (KR)

(21) Appl. No.: 16/606,258

(22) PCT Filed: Apr. 18, 2017
(86) PCT No.: PCT/KR2017/004134

§ 371 Date: Oct. 18, 2019

(51) Int. Cl. H04N 19/61; H04N 19/172; H04N 19/119; H04N 19/105; H04N 19/159; H04N 19/593; H04N 19/174

(52) U.S. Cl. CPC H04N 19/61; H04N 19/172; H04N 19/119; H04N 19/174; H04N 19/159; H04N 19/593; H04N 19/105

(57) ABSTRACT

Provided are an image decoding method and an image decoding device for performing the image decoding method. The method of decoding an image includes determining at least one coding unit for splitting a current frame that is one of at least one frame included in the image, determining at least one prediction unit and at least one transformation unit included in a current coding unit that is one of the at least one coding unit, obtaining residual sample values by inversely transforming a signal obtained from a bitstream, obtaining a modified residual sample value by performing a rotation operation on the residual sample values included in a current transformation unit that is one of the at least one transformation unit, and generating a reconstructed signal included in the current coding unit by using a predicted sample value included in the at least one prediction unit and the modified residual sample value. The rotation operation is performed by applying a rotation matrix kernel to coordinates including a first residual sample value and a second residual sample value included in the residual sample values.

### TECHNICAL FIELD

A method and device according to an embodiment are directed to efficiently performing prediction in an image encoding or decoding process.

### BACKGROUND ART

Image data is encoded by a codec conforming to a data compression standard, e.g., the Moving Picture Expert Group (MPEG) standard, and then is stored in a recording medium or transmitted through a communication channel in the form of a bitstream.

As hardware capable of reproducing and storing high-resolution or high-quality image content has been developed and become popularized, a codec capable of efficiently encoding or decoding the high-resolution or high-quality image content is in high demand. The encoded image content may be reproduced by decoding it. Currently, methods of effectively compressing high-resolution or high-quality image content are used.

A core transformation process may be performed on a residual signal by discrete cosine transformation (DCT) or discrete sine transformation (DST) in a process of encoding or decoding high-resolution or high-quality image content, and a secondary transformation process may be performed on a result of the core transformation process.

### DESCRIPTION OF EMBODIMENTS

### TECHNICAL PROBLEM

According to the related art, the core transformation process and the secondary transformation process are processes applied to a residual sample value which is the difference between an original sample value and a predicted sample value in an encoding process, and a quantization process is performed on a resultant transformed residual sample value. Thus, in a decoding process, the residual sample value is obtained by performing, on received information, an inverse quantization process and processes reverse to the core transformation process and the secondary transformation process, and a reconstruction signal is produced by adding a prediction sample value to the residual sample value.

Therefore, in order to improve compression and reproduction efficiencies of an image, a transformation process should be performed to increase core transformation efficiency to reduce an error rate of the quantization process.

### SOLUTION TO PROBLEM

According to an aspect, an image decoding method includes determining at least one coding unit for splitting a current frame which is one of at least one frame included in the image, determining at least one prediction unit and at least one transformation unit included in a current coding unit which is one of the at least one coding unit, obtaining residual sample values by inversely transforming a signal obtained from a bitstream, obtaining a modified residual sample value by performing a rotation operation on the residual sample values included in a current transformation unit which is one of the at least one transformation unit, and generating a reconstructed signal included in the current coding unit by using a predicted sample value included in the at least one prediction unit and the modified residual sample value, wherein the rotation operation is performed by applying a rotation matrix kernel to coordinates including a first residual sample value and a second residual sample value which are included in the residual sample values.

According to another aspect, an image decoding device includes a rotation operation unit configured to perform a rotation operation on residual sample values included in a current transformation unit, which is one of at least one transformation unit; and a decoder configured to determine at least one coding unit for splitting a current frame which is one of at least one frame included in the image, determine at least one prediction unit and at least one transformation unit included in a current coding unit which is one of the at least one coding unit, obtaining residual sample values by inversely transforming a signal obtained from a bitstream, and generate a reconstructed signal included in the current coding unit by using a modified residual sample value obtained by performing a rotation operation and a predicted sample value included in the at least one prediction unit, wherein the rotation operation is performed by applying a rotation matrix kernel to coordinates including a first residual sample value and a second residual sample value which are included in the residual sample values.

According to another aspect, there is provided a computer-readable recording medium storing a computer program for performing the image decoding method.

### ADVANTAGEOUS EFFECTS OF DISCLOSURE

According to various embodiments, a modified residual sample value obtained by performing a rotation operation on a residual sample value before frequency conversion of the residual sample value may be used in an encoding process, and an inverse rotation process may be performed on the modified residual sample value in a decoding process. Thus, errors which may occur during transformation and inverse transformation of the residual sample value may be reduced to improve encoding and decoding efficiencies of an image.

### BRIEF DESCRIPTION OF DRAWINGS

FIG. 1A is a block diagram of an image decoding device for performing an image decoding process of performing a rotation operation to produce a modified residual sample value, according to an embodiment.

FIG. 1B is a block diagram of an image encoding device for performing an image encoding process of performing the rotation operation to produce a modified residual sample value, according to an embodiment.

FIG. 2 is a flowchart of an image decoding method of decoding an image, based on a modified residual sample value produced by the rotation operation, according to an embodiment.

FIG. 3A is a diagram illustrating a direction in which the rotation operation is performed, according to an embodiment.

FIG. 3B illustrates a process of performing the rotation operation on a current transformation unit by using a predetermined angle, according to an embodiment.

FIG. 3C illustrates various locations at which the rotation operation may be performed, according to an embodiment.

FIG. 3D is a diagram of various examples of a direction in which the rotation operation is performed, according to an embodiment.

FIG. 4 is a flowchart of a process of performing the rotation operation according to whether a prediction mode related to a current coding unit is an intra-prediction mode, according to an embodiment.

FIG. 5 is a flowchart of a process of performing the rotation operation, based on whether an intra-prediction mode related to at least one prediction unit included in a current coding unit is a directional intra-prediction mode, according to an embodiment.

FIGS. 6A and 6B are diagrams for explaining a method of obtaining a modified residual sample value by performing the rotation operation, based on a prediction direction of a directional intra-prediction mode, according to an embodiment.

FIG. 7 illustrates changing a rotation angle of coordinates between a start position and an end position of the rotation operation in a block, according to an embodiment.

FIG. 8 is a flowchart of a method of performing the rotation operation, based on first information and second information, according to an embodiment.

FIG. 9 is a flowchart of a method of performing the rotation operation, based on first information, second information, and third information, according to an embodiment.

FIG. 10 illustrates a process of determining at least one coding unit by splitting a current coding unit, according to an embodiment.

FIG. 11 illustrates a process of determining at least one coding unit by splitting a non-square coding unit, according to an embodiment.

FIG. 12 illustrates a process of splitting a coding unit based on at least one of block shape information and split shape information, according to an embodiment.

FIG. 13 illustrates a method of determining a predetermined coding unit from among an odd number of coding units, according to an embodiment.

FIG. 14 illustrates an order of processing a plurality of coding units when the plurality of coding units are determined by splitting a current coding unit, according to an embodiment.

FIG. 15 illustrates a process of determining that a current coding unit is to be split into an odd number of coding units, when the coding units are not processable in a predetermined order, according to an embodiment.

FIG. 16 illustrates a process of determining at least one coding unit by splitting a first coding unit, according to an embodiment.

FIG. 17 illustrates that a shape into which a second coding unit is splittable is restricted when the second coding unit having a non-square shape, which is determined by splitting a first coding unit, satisfies a predetermined condition, according to an embodiment.

FIG. 18 illustrates a process of splitting a square coding unit when split shape information indicates that the square coding unit is not to be split into four square coding units, according to an embodiment.

FIG. 19 illustrates that a processing order between a plurality of coding units may be changed depending on a process of splitting a coding unit, according to an embodiment.

FIG. 20 illustrates a process of determining a depth of a coding unit as a shape and size of the coding unit change, when the coding unit is recursively split such that a plurality of coding units are determined, according to an embodiment.

FIG. 21 illustrates depths that are determinable based on shapes and sizes of coding units, and part indexes (PIDs) that are for distinguishing the coding units, according to an embodiment.

FIG. 22 illustrates that a plurality of coding units are determined based on a plurality of predetermined data units included in a picture, according to an embodiment.

FIG. 23 illustrates a processing block serving as a unit for determining a determination order of reference coding units included in a picture, according to an embodiment.

### BEST MODE

According to an aspect, an image decoding method includes determining at least one coding unit for splitting a current frame which is one of at least one frame included in the image, determining at least one prediction unit and at least one transformation unit included in a current coding unit which is one of the at least one coding unit, obtaining residual sample values by inversely transforming a signal obtained from a bitstream, obtaining a modified residual sample value by performing a rotation operation on the residual sample values included in a current transformation unit which is one of the at least one transformation unit, and generating a reconstructed signal included in the current coding unit by using a predicted sample value included in the at least one prediction unit and the modified residual sample value, wherein the rotation operation is performed by applying a rotation matrix kernel to coordinates including a first residual sample value and a second residual sample value included in the residual sample values.

In an embodiment, in the image decoding method, the obtaining of the modified residual sample value may include obtaining a modified residual signal by performing the rotation operation, based on at least one of a position of a sample in the current transformation unit at which the rotation operation is started, an order in which the rotation operation is performed on the current transformation unit, and an angle by which the coordinates are shifted through the rotation operation.

In an embodiment, in the image decoding method, the obtaining of the modified residual sample value may include determining at least one of the position of the sample at which the rotation operation is started, the order in which the rotation operation is performed, and the angle by which the coordinates are shifted, based on at least one of an intra-prediction mode performed with respect to the current coding unit, a partition mode for determining the at least one prediction unit, and a size of a block on which the rotation operation is performed; and obtaining the modified residual signal by performing the rotation operation, based on at least one of the position, the order, or the angle.

In an embodiment, in the image decoding method, the determining of at least one of the position of the sample at which the rotation operation is started, the order in which the rotation operation is performed, and the angle by which the coordinates are shifted may include, when the intra-prediction mode performed with respect to the at least one prediction unit is a directional intra-prediction mode, determining at least one of the position of the sample at which the rotation operation is started, the order in which the rotation operation is performed, and the angle by which the coordinates are shifted, based on a prediction direction used in the directional intra-prediction mode.

In an embodiment, in the image decoding method, the determining of at least one of the position of the sample at which the rotation operation is started, the order in which the rotation operation is performed, and the angle by which the coordinates are shifted may include obtaining prediction mode information indicating the prediction direction from the bitstream; and determining the order in which the rotation operation is performed according to one of a plurality of directions, based on the prediction mode information.

In an embodiment, in the image decoding method, the obtaining of the modified residual sample value may include determining a maximum angle and a minimum angle by which the coordinates are shifted through the rotation operation; determining a start position and an end position of the rotation operation in the current transformation unit; and obtaining the modified residual sample value by performing the rotation operation on the coordinates, which are determined by the residual sample values at the start position and the end position, within a range of the maximum angle and the minimum angle.

In an embodiment, in the image decoding method, the obtaining of the modified residual sample value may include obtaining the modified residual sample value by performing the rotation operation on the coordinates determined by the residual sample values at the start position and the end position, wherein the angle by which the coordinates are shifted is changed at a certain ratio within the range of the maximum angle and the minimum angle.

In an embodiment, in the image decoding method, the obtaining of the modified residual sample value by performing the rotation operation may include obtaining first information for each predetermined data unit from the bitstream, the first information indicating whether the rotation operation is to be performed when prediction is performed in a predetermined prediction mode; and obtaining the modified residual sample value by performing the rotation operation on at least one transformation unit included in the predetermined data unit, based on the first information.

In an embodiment, in the image decoding method, the obtaining of the modified residual sample value may include, when the first information indicates that the rotation operation is to be performed, obtaining second information for each current coding unit from the bitstream, the second information indicating a rotation-operation performance method; determining a method of performing the rotation operation on the current coding unit, based on the second information; and obtaining the modified residual sample value by performing the rotation operation on the current transformation unit according to the determined method, wherein the determined method may be configured based on at least one of the position of the sample at which the rotation operation is started, the order in which the rotation operation is performed, or the angle by which the coordinates are shifted.

In an embodiment, in the image decoding method, the obtaining of the first information may include, when a prediction mode, indicated by the first information, in which the rotation operation is to be performed is the same as a prediction mode performed with respect to the current coding unit, obtaining second information for each of the at least one coding unit from the bitstream, the second information indicating whether the rotation operation is to be performed on the current coding unit; and performing the rotation operation in the current coding unit, based on the second information.

In an embodiment, in the image decoding method, the performing of the rotating operation on the current coding unit, based on the second information, may include when the second information indicates that the rotation operation is to be performed on the current coding unit, obtaining third information for each of the at least one transformation unit from the bitstream, the third information indicating a method of performing the rotation operation on the current coding unit; and obtaining the modified residual sample value by performing the rotation operation on the current coding unit according to the method indicated by the third information, wherein the method is configured based on at least one of the position of the sample at which the rotation operation is started, the order in which the rotation operation is performed, or the angle by which the coordinates are shifted.

In an embodiment, when the prediction mode, indicated by the first information, in which the rotation operation is to be performed is different from the prediction mode performed with respect to the current coding unit, the image decoding method includes producing the reconstructed signal by using the residual sample value and the predicted sample value without obtaining the second information from the bitstream.

In an embodiment, in the image decoding method, the predetermined data unit may include a largest coding unit, a slice, a slice segment, a picture, or a sequence, which includes the current coding unit.

According to another aspect, an image decoding device includes a rotation operation unit configured to perform a rotation operation on residual sample values included in a current transformation unit, which is one of at least one transformation unit; and a decoder configured to determine at least one coding unit for splitting a current frame which is one of at least one frame included in the image, determine at least one prediction unit and at least one transformation unit included in a current coding unit which is one of the at least one coding unit, obtaining residual sample values by inversely transforming a signal obtained from a bitstream, and produce a reconstructed signal included in the current coding unit by using a modified residual sample value obtained by performing a rotation operation and a predicted sample value included in the at least one prediction unit, wherein the rotation operation is performed by applying a rotation matrix kernel to coordinates including a first residual sample value and a second residual sample value included in the residual sample values.

According to another aspect, there is provided a computer-readable recording medium storing a computer program for performing the image decoding method.

### MODE OF DISCLOSURE

Advantages and features of the present disclosure and methods of achieving them will be apparent from the following description of embodiments in conjunction with the accompanying drawings. However, the present disclosure is not limited to embodiments set forth herein and may be embodied in many different forms. The embodiments are merely provided so that this disclosure will be thorough and complete and will fully convey the scope of the disclosure to those of ordinary skill in the art.

The terms used herein will be briefly described and then the present disclosure will be described in detail.

In the present disclosure, general terms that have been widely used nowadays are selected, when possible, in consideration of functions of the present disclosure, but non-general terms may be selected according to the intentions of technicians in the this art, precedents, or new technologies, etc. Some terms may be arbitrarily chosen by the present applicant. In this case, the meanings of these terms will be explained in corresponding parts of the disclosure in detail. Thus, the terms used herein should be defined not based on the names thereof but based on the meanings thereof and the whole context of the present disclosure.

As used herein, the singular forms “a”, “an” and “the” are intended to include the plural forms as well, unless the context clearly indicates otherwise.

It will be understood that when an element is referred to as “including” another element, the element may further include other elements unless mentioned otherwise. The term “unit” used herein should be understood as software or a hardware component, such as a FPGA or an ASIC, which performs certain functions. However, the term “unit” is not limited to software or hardware. The term “unit” may be configured to be stored in an addressable storage medium or to reproduce one or more processors. Thus, the term “unit” may include, for example, components, such as software components, object-oriented software components, class components, and task components, processes, functions, attributes, procedures, subroutines, segments of program code, drivers, firmware, microcode, a circuit, data, database, data structures, tables, arrays, and parameters. Functions provided in components and “units” may be combined to a small number of components and “units” or may be divided into sub-components and “sub-units”.

The term “image”, when used herein, should be understood to include a static image such as a still image of a video, and a moving picture, i.e., a dynamic image, which is a video.

The term “sample”, when used herein, refers to data allocated to a sampling position of an image, i.e., data to be processed. For example, samples may be pixel values in a spatial domain, and transform coefficients in a transform domain. A unit including at least one sample may be defined as a block.

Hereinafter, embodiments of the present disclosure will be described in detail with reference to the accompanying drawings such that the embodiments may be easily implemented by those of ordinary skill in the art. For clarity, parts irrelevant to a description of the present disclosure are omitted in the drawings.

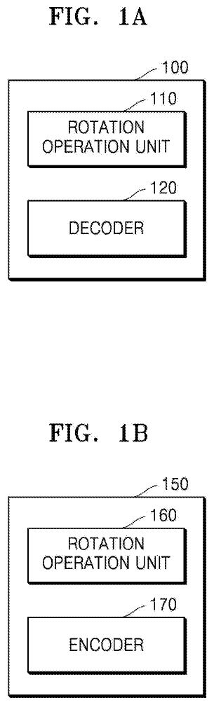

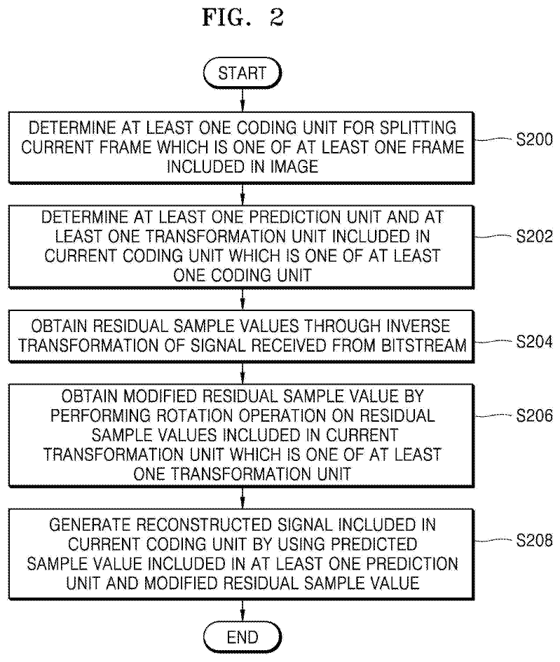

FIG. 1 A is a block diagram of an image decoding device 100 for performing an image decoding process of performing a rotation operation to produce a modified residual sample value, according to an embodiment.

In an embodiment, the image decoding device 100 may include a rotation operation unit 110 configured to obtain a modified residual sample value by performing a rotation operation on a residual sample value obtained by inverse transforming information obtained from a bitstream, and a decoder 120 configured to determine at least one coding unit for splitting a current frame which is one of at least one frame included in an image, determine at least one prediction unit and at least one transformation unit included in a current coding unit which is one of the at least one coding unit, obtain a residual sample value by inversely transforming a signal obtained from the bitstream, and produce a reconstructed signal included in the current coding unit by using the modified residual sample value obtained by the rotation and a predicted sample value included in the at least one prediction unit. Operations of the image decoding device 100 will be described with respect to various embodiments below.

In an embodiment, the decoder 120 may decode an image by using a result of a rotation operation performed by the rotation operation unit 110. Alternatively, the decoder 120, which is a hardware component such as a processor or a CPU, may perform the rotation operation performed by the rotation operation unit 110. Decoding processes which are not described as particularly performed by the rotation operation unit 110 in various embodiments described below may be interpreted as being performed by the decoder 120.

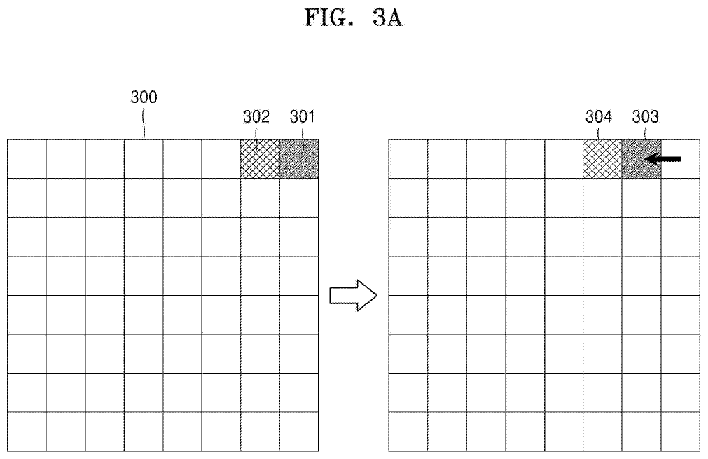

FIG. 2 is a flowchart of an image decoding method of decoding an image by the image decoding device 100, based on a modified residual sample value produced by the rotation operation, according to an embodiment.

In an embodiment, in operation S200, the decoder 120 of the image decoding device 100 may determine at least one coding unit for splitting a current frame which is one of at least one frame included in an image. In operation S220, when at least one coding unit is determined, the decoder 120 may determine at least one prediction unit and at least one transformation unit included in a current coding unit which is one of the at least one coding unit.

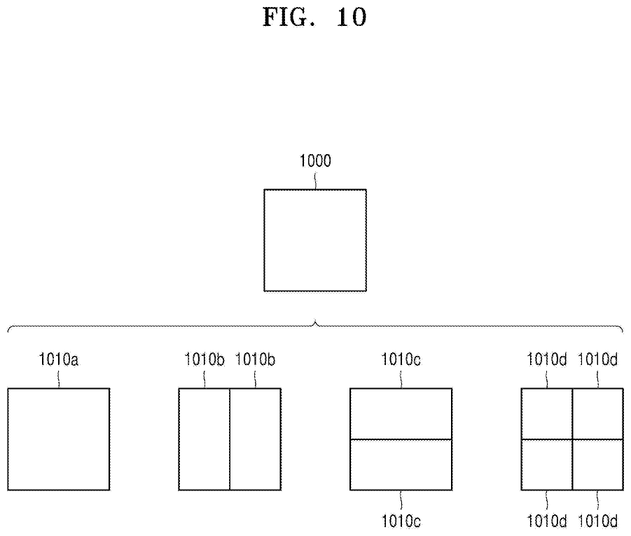

In an embodiment, the decoder 120 may split the current frame, which is one of frames of the image, into various data units. In an embodiment, the decoder 120 may perform an image decoding process using various types of data units, such as sequences, frames, slices, slice segments, largest coding units, coding units, prediction units, transformation units, and the like, to decode the image, and obtain information related to the data units from a bitstream of each of the data units. Forms of various data units according to various embodiments, which may be used by the decoder 120, will be described with reference to FIG. 10 and other drawings below.

In an embodiment, the decoder 120 may determine at least one coding unit included in the current frame, and determine a prediction unit and a transformation unit included in each of the at least one coding unit. In an embodiment, a prediction unit included in a coding unit may be defined as a data unit that is a reference for performing prediction on the coding unit, and a transformation unit included in the coding unit may be defined as a data unit for performing inverse transformation to produce a residual sample value included in the coding unit.

In an embodiment, a coding unit, a prediction unit, or a transformation unit may be defined as different data units that are distinguished from one another, or may be same data units but be referred to differently according to roles thereof and used in a decoding process. For example, the decoder 120 may determine a prediction unit or a transformation unit, which is a different data unit included in a coding unit, by a process different from a coding unit determination process, and perform prediction based on the prediction unit, or may perform prediction or inverse transformation, based on at least one unit that is splittable into various forms. Hereinafter, for convenience of explanation of functions of data units, the data units may be referred to differently as a coding unit, a prediction unit and a transformation unit according to functions thereof.

In an embodiment, the decoder 120 may perform intra prediction on the current coding unit in units of prediction units or may perform inter prediction on the current coding unit in prediction units by using the current frame and a reference picture obtained from a reconstruction picture buffer. The decoder 120 may determine a partition mode and a prediction mode of each coding unit among coding units having a tree structure, in consideration of a maximum size and a maximum depth of a largest coding unit.

In an embodiment, the decoder 120 may determine a depth of a current largest coding unit by using split information for each depth. When the split information indicates that a current depth is not split any longer, the current depth is the depth. Thus, the decoder 120 may decode a coding unit of the current depth by using a partition mode, a prediction mode, and transformation unit size information of prediction units thereof.

In an embodiment, in operation S204, the decoder 120 may obtain residual sample values through inverse transformation of a signal received from a bitstream.

In an embodiment, the decoder 120 may determine a transformation unit by splitting a coding unit, which is determined according to a tree structure, according to a quad tree structure. For inverse transformation of each largest coding unit, the decoder 120 may inversely transform each coding unit based on transformation units by reading information regarding the transformation units for each coding unit according to a tree structure. Through inverse transformation, pixel values of each coding unit in a spatial domain may be reconstructed. In an embodiment, the decoder 120 may convert components of a frequency domain into components of a spatial domain through an inverse transform process. In this case, the decoder 120 may use various core transformation methods and various secondary transformation methods. For example, the decoder 120 may use a discrete sine transform (DST) or a discrete cosine transform (DCT) as a core transformation scheme to obtain a residual sample value. Furthermore, an inverse transformation process associated with a method such as a non-separable secondary transform may be performed as a secondary transformation process to generate an input value for core transformation during an image reconstruction process. The decoder 120 may obtain a residual sample value through the inverse transformation process.

In an embodiment, in operation S206, the image decoding device 100 may obtain a modified residual sample value by performing a rotation operation on residual sample values included in a current transformation unit which is one of the at least one transformation unit.

In an embodiment, the image decoding device 100 may include a rotation operation unit 110 configured to perform the rotation operation on a residual sample value which is a result of inversely transforming a component of a frequency domain obtained from a bitstream into a component of a spatial domain. To perform the rotation operation, the rotation operation unit 110 may determine coordinates by using residual sample values included in a current transformation unit which is one of at least one transformation unit. For example, the rotation operation unit 110 may perform the rotation operation by setting a first residual sample value, which is a first sample value, and a second residual sample value, which is a second sample value, to x and y coordinates, respectively, according to an order in which the rotation operation is performed.

In an embodiment, the rotation operation unit 110 may apply a rotation matrix to perform the rotation operation on the coordinates (x, y) consisting of the first residual sample value and the second residual sample value. The rotation operation unit 110 may produce modified coordinates (x′, y′) by performing the rotation operation by applying a predetermined rotation matrix to the coordinates (x, y). That is, the rotation operation unit 110 may perform the rotation operation by using the following rotation matrix.

$$[ \begin{matrix}{x}^{′} \\ {y}^{′}\end{matrix} ] = [ \begin{matrix}cos θ & - sin θ \\ sin θ & cos θ\end{matrix} ] [ \begin{matrix}x \\ y\end{matrix} ] \qquad [ Equation 1 ]$$

$$R ( θ ) = [ \begin{matrix}cos θ & - sin θ \\ sin θ & cos θ\end{matrix} ] ,$$

That is, when R(8) is defined as the rotation operation unit 110 may produce (x′, y′) by matrix-multiplying R(8) to the coordinates consisting of the first residual sample value and the second residual sample value as an x-coordinate and a y-coordinate. The rotation operation unit 110 may use (x′, y′), which is the result of the rotation operation, as a modified residual sample value. That is, x, which is the first residual sample value, may be converted into x ‘ and y, which is the second residual sample value, may be converted into y’ according to the result of the rotation operation. The rotation operation unit 110 may use R(8) as a matrix kernel to perform a rotation operation. However, a method of performing the rotation operation using the matrix kernel should not be construed as being limited to Equation 1 above, and the rotation operation may be performed using matrices of various sizes and numbers, based on linear algebra available to those of ordinary skill in the art.

In an embodiment, the rotation operation unit110 may obtain a modified residual signal by performing the rotation operation, based on at least one of a position of a sample of a current transformation unit at which the rotation operation is started, an order of performing the rotation operation in the current transformation unit, or an angle by which coordinates are shifted through the rotation operation.

In an embodiment, in operation S208, the decoder 120 may generate a reconstructed signal included in the current coding unit by using a predicted sample value included in the at least one prediction unit and the modified residual sample value. The decoder 120 may generate the reconstructed signal included in the current coding unit by adding the modified residual sample value obtained in operation S206 to the predicted sample value. In an embodiment, the decoder 120 may additionally perform a filtering process to reduce errors that may occur between boundaries of blocks included in the current coding unit.

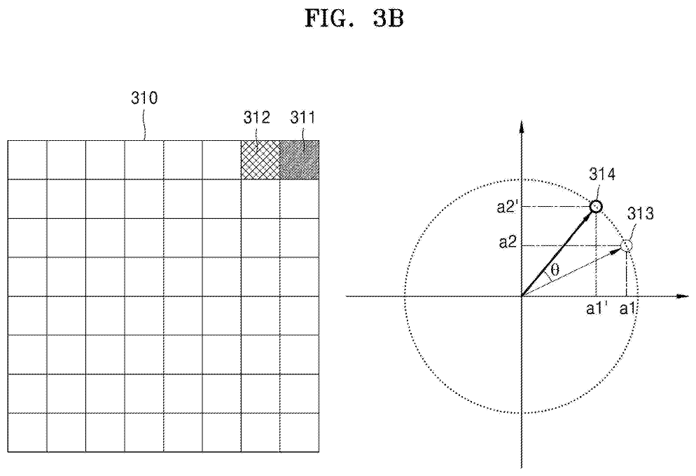

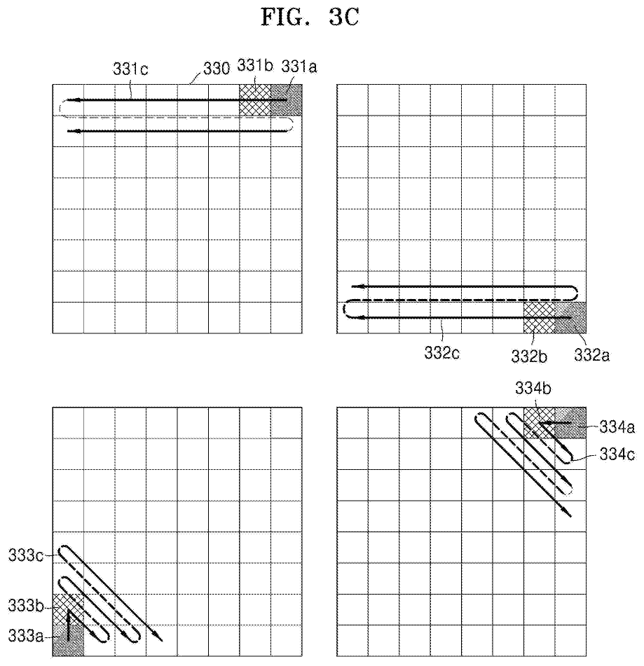

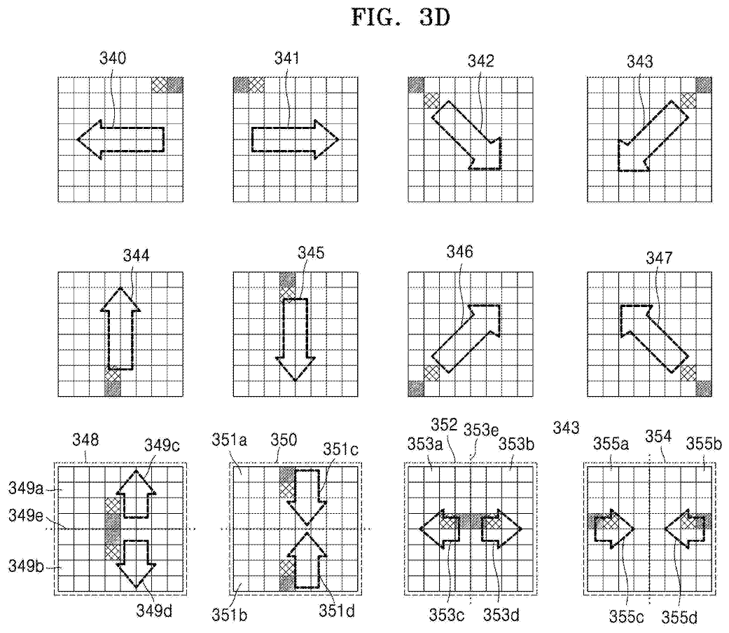

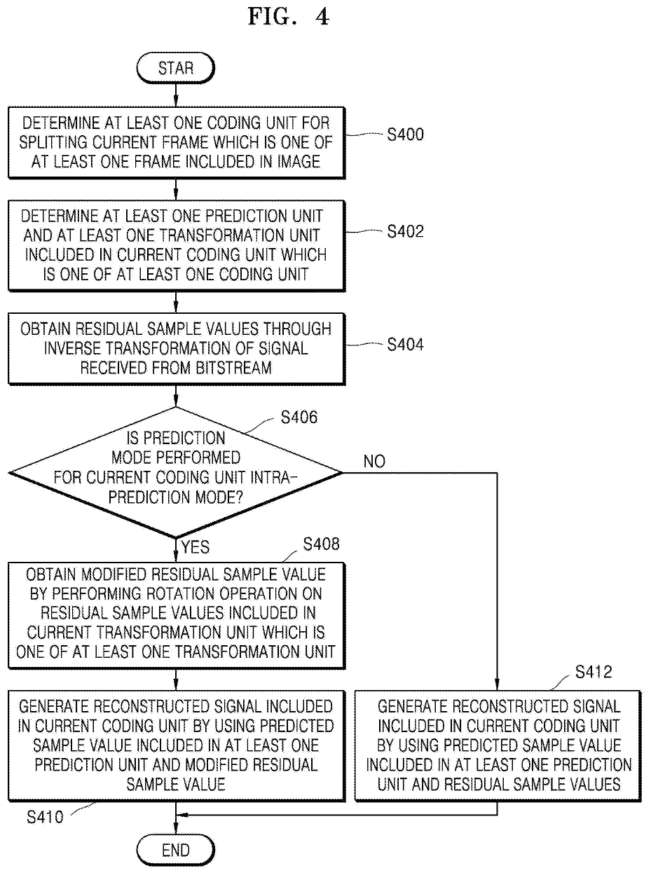

FIG. 3A is a diagram illustrating a direction in which the rotation operation is performed by the image decoding device 100, according to an embodiment.

In an embodiment, the rotation operation unit 110 may determine an order in which the rotation operation is performed within a current transformation unit. Referring to FIG. 3A, a current transformation unit 300 may include values of 8x8 samples, and the rotation operation unit 110 may determine a sample adjacent to a left side of a first residual sample 301 to be a second residual sample 302. The rotation operation unit 110 may perform the rotation operation by using a sample value of the first residual sample 301 and a sample value of the second residual sample 302. After the rotation operation using the first residual sample 301 and the second residual sample 302 is completed, the rotation operation may be performed using samples at different positions in a predetermined order.

In an embodiment, the rotation operation unit 110 may determine an order in which the rotation operation is performed on the current transformation unit 300 to be a left direction. Accordingly, after the rotation operation using the first residual sample 301 and the second residual sample 302, the rotation operation unit 110 may perform the rotation operation by using a sample value of a third residual sample adjacent to a left side of the second residual sample 302. That is, after the rotation operation using a first residual sample and a second residual sample, the rotation operation unit 110 may perform the rotation operation by using the second residual sample and a third residual sample.

In another embodiment, after the rotation operation using the first residual sample and the second residual sample, the rotation operation unit 110 may perform the rotation operation by using the third residual sample and a fourth residual sample adjacent to a left side of the third residual sample.

FIG. 3B illustrates a process of performing the rotation operation on a current transformation unit by using a predetermined angle, the process being performed by the image decoding device 100, according to an embodiment.

In an embodiment, the rotation operation unit 110 may rotate coordinates consisting of a first residual sample value and a second residual sample value by an angle by which coordinates are shifted through the rotation operation. Referring to FIG. 3B, coordinates 313 consisting of a sample value al of a first residual sample 311 and a sample value a2 of a second residual sample 312 which are included in a current transformation unit 310 are rotated by a predetermined angle 8 as a result of performing the rotation operation and thus are shifted to new coordinates 314. Thus, coordinates are shifted from a1, which is a first residual sample, and a2, which is a second residual sample value, to a1′ and a2′, respectively. That is, the coordinates (a1, a2) may be shifted into (a1′, a2′) through the rotation operation, and used later in a decoding process.

In an embodiment, in the image decoding device 100, an angle by which coordinates are shifted may be determined based on at least one of an intra prediction mode performed with respect to at least one prediction unit included in a current coding unit, a partition mode for determining at least one prediction unit, or a size of a block on which the operation is performed.

In an embodiment, the rotation operation unit 110 may determine an angle by which coordinates consisting of values of samples in a transformation unit included in a current coding unit are changed, based on an intra prediction mode related to at least one prediction unit included in the current coding unit. In an embodiment, the image decoding device 100 may obtain index information indicating an intra prediction mode from a bitstream to determine a direction in which prediction is performed. In an embodiment, the rotation operation unit 110 may variously determine an angle by which coordinates are shifted by performing the rotation operation on a current transformation unit, based on the index information indicating the intra prediction mode. For example, the rotation operation may be performed using a different angle according to index information indicating an intra prediction mode related to at least one prediction unit included in the current coding unit. For example, the rotation operation unit 110 may rotate coordinates consisting of values of samples of a current transformation unit by 81 when at least one prediction unit is related to a directional intra-prediction mode among intra prediction modes, and may rotate the coordinates consisting of the values of the samples of the current transformation unit by 82 when the at least one prediction unit is related to a non-directional intra-prediction mode (e.g., a DC mode or a planar mode) among the intra prediction modes. In detail, the rotation operation unit 110 may differently set an angle by which coordinates are shifted according to a prediction direction in the directional intra prediction mode. However, features of an angle by which coordinates are shifted according to the type of intra prediction mode described above should not be construed as being limited to 81 and 82 described above, and angles variously classified for each intra prediction mode according to a certain criterion may be used by the rotation operation unit 110.

In an embodiment, the rotation operation unit 110 may determine an angle by which coordinates consisting of values of samples in a transformation unit included in a current coding unit are shifted, based on a partition mode of the current coding unit. In an embodiment, the decoder 120 may split a 2N×2N current coding unit into at least one prediction unit of one of various types of partition modes, e.g., 2N×2N, 2N×N, N×2N, N×N, 2N×nU, 2N×nD, nL×2N, and nR×2N, and the rotation operation unit 110 may change an angle by which coordinates are shifted in a transformation unit included in each partition included in a current prediction unit according to a partition shape. In an embodiment, the rotation operation unit 110 may determine an angle by which coordinates are shifted to 81 in the case of a transformation unit included in a symmetric partition and to 82 in the case of a transformation unit included in an asymmetric partition.

In an embodiment, the rotation operation unit 110 may use a width or height of a partition included in a current coding unit so as to determine an angle by which coordinates consisting of values of samples included in a current transformation unit are rotated to change the coordinates. In an embodiment, the rotation operation unit 110 may determine an angle by which coordinates consisting of sample values of a transformation unit included in a partition having a width of N are rotated to be 8, and determine an angle by which coordinates consisting of sample values of a transformation unit included in a partition having a width of 2N are rotated to be 28. In an embodiment, the rotation operation unit 110 may determine an angle by which coordinates consisting of sample values of a transformation unit included in a partition having a height of N are rotated to be 8, and determine an angle by which coordinates consisting of sample values of a transformation unit included in a partition having a height of 2N are rotated to be 28.

In an embodiment, the rotation operation unit 110 may determine a rotation angle, based on a height or a width of a partition, according to whether a width or a height of a current coding unit is to be split according to a shape of the partition. In an embodiment, when the width of the current coding unit is to be split according to the shape of the partition, an angle by which coordinates consisting of sample values of a transformation unit included in a partition of a height of N are rotated may be determined to be 8, and an angle by which coordinates consisting of sample values of a transformation unit included in a partition of a height of 2N are rotated may be determined to be 28. In an embodiment, when the height of the current coding unit is to be split according to the shape of the partition, an angle by which coordinates consisting of sample values of a transformation unit included in a partition of a width of N are rotated may be determined to be 8, and an angle by which coordinates consisting of sample values of a transformation unit included in a partition of a width of 2N are rotated may be determined to be 28.

FIG. 3C illustrates various locations at which the rotation operation may be performed, according to an embodiment.

In an embodiment, the rotation operation unit 110 may determine a direction in which the rotation operation is to be performed so as to perform the rotation operation using samples included in a current transformation unit 330, and determine a sample position in the current transformation unit 330, at which the rotation operation is to be started. Referring to FIG. 3C, in an embodiment, the rotation operation unit 110 may determine a direction in which the rotation operation is to be performed on the current transformation unit 330 to be a left direction 331c, and determine a sample position at which the rotation operation is to be started to be an upper rightmost sample 331a. A sample 331b adjacent to the upper rightmost sample 331a determined as the sample position at which the rotation operation is to be started may be determined, based on the left direction 331c in which the rotation operation is to be performed. When the rotation operation is performed up to a sample adjacent to a boundary of the current transformation unit 330 in the left direction 331c in which the rotation operation is to be performed, the rotation operation unit 110 may perform the rotation operation again starting from a sample at a row or column in which the upper rightmost sample 331a, based on the determined left direction 331c.

In another embodiment, the rotation operation unit 110 may determine a direction in which the rotation operation is to be performed on the current transformation unit 330 to be a left direction 332c, determine a sample position at which the rotation operation is to be started to be a lower rightmost sample 332a, and determine a sample 332b adjacent to the lower rightmost sample 332a in the left direction 332c in which the rotation operation is to be performed.

In an embodiment, the rotation operation unit 110 may determine a direction in which the rotation operation is to be performed on the current transformation unit 330 to be a lower right direction 333c, determine a sample position at which the rotation operation is to be started to be a lower leftmost sample 333a, and determine a sample 333b adjacent to the lower leftmost sample 333a in the lower right direction 333c in which the rotation operation is to be performed.

In another embodiment, the rotation operation unit 110 may determine a direction in which the rotation operation is to be performed on the current transformation unit 330 to be a lower right direction 334c, determine a sample position at which the rotation operation is to be started to be an upper rightmost sample 334a, and determine a sample 334b adjacent to the upper rightmost sample 334a in the lower right direction 334c in which the rotation operation is to be performed.

In addition to the various embodiments described above, the image decoding device 100 may perform the rotation operation using sample values of a current transformation unit, based on various rotation-operation performance directions and various positions at which the rotation operation is started.

FIG. 3D illustrates various examples of a direction in which the rotation operation may be performed by the image decoding device 100, according to an embodiment.

In an embodiment, the rotation operation unit 110 may determine a direction in which the rotation operation described above with respect to various embodiments is to be performed, based on a predetermined data unit. For example, the rotation operation unit 110 may use a current transformation unit as a predetermined data unit. In this case, a rotation operation process using sample values included in the current transformation unit may be performed in the same direction. Referring to FIG. 3D, a rotation operation process performed on a predetermined data unit may be performed in a left direction 340, a right direction 341, a lower right direction 342, a lower left direction 343, an upper direction 344, a lower direction 345, am upper right direction 346, an upper left direction 347, and the like. However, the direction in which the rotation operation is performed should not be construed as being limited to the directions shown in FIG. 3D, and may be variously interpreted within a range in which those of ordinary skill in the art may easily perform data processing while moving samples within a predetermined data unit.

In an embodiment, the rotation operation unit 110 may perform a rotation operation process in a predetermined data unit in different directions. In an embodiment, when the rotation operation is performed using values of samples divided based on a boundary line dividing at least one of a width or a height of a predetermined data unit, the rotation operation unit 110 may perform the rotation operation on the values of the samples divided by the boundary line in different directions. Referring to FIG. 3D, the rotation operation unit 110 may determine a rotation operation process to be performed on sample regions 349a and 349b divided with respect to a boundary line 349e dividing a height of a predetermined data unit 348 in different directions (e.g., to be differently performed on sample values of regions divided by a boundary line in an upward direction and a downward direction).

In another embodiment, for each predetermined data unit, the rotation operation unit 110 may determine the rotation operation process to be performed on sample values of a plurality of blocks included in each predetermined data unit in different directions. In an embodiment, the rotation operation unit 110 may determine the second blocks 349a and 349b by dividing the first block 348, and determine a direction in which the rotation operation process is to be performed, based on the first block 348 and the second blocks 349a and 349b which are in an inclusion relation. Referring to FIG. 3D, the rotation operation unit 110 may horizontally divide the first block 348 to determine the second blocks 349a and 349b. The rotation operation unit 110 may determine a direction in which the rotation operation is to be performed by using sample values included in the second blocks 349a and 349b included in the first block 348, based on the first block 348. For example, the rotation operation unit 110 may determine directions in which the rotation operation is to be performed such that the rotation operation is performed on the second blocks 349a and 349b included in the first block 348 in different directions associated with each other (e.g., opposite directions or a direction rotated clockwise by a certain angle with respect to a predetermined direction). Referring to FIG. 3D, the rotation operation unit 110 may determine that the rotation operation is to be performed on the second blocks 349a and 349b included in the first block 348 in an downward direction 351c and a upward direction 351d, respectively. In this case, samples at which the rotation operation is started may be samples adjacent to the boundary line 349e dividing the first block 348.

In another embodiment, the rotation operation unit 110 may horizontally divide a first block 350 to determine second blocks 351a and 351b. The rotation operation unit 110 may determine a direction of performing the rotation operation using the sample values included in the second blocks 351a and 351b, based on the first block 350, and thus may determine that the rotation operation is to be performed on the second block 351a which is an upper block in the downward direction 351c and the second block 351b which is a lower block in the upward direction 351d. In this case, the rotation operation unit 110 may determine sample positions at which the rotation operation is started as samples adjacent to an upper boundary and a lower boundary of the first block 350.

In another embodiment, the rotation operation unit 110 may vertically divide a first block 352 to determine second blocks 353a and 353b. The rotation operation unit 110 may determine a direction of performing the rotation operation using the sample values included in the second blocks 353a and 353b, based on the first block 352, and thus may determine that the rotation operation is to be performed on the second block 353a which is a left block in a left direction 353c and the second block 353b which is a right block in a right direction 353d. In this case, the rotation operation unit 110 may determine sample positions at which the rotation operation is started as samples adjacent to a boundary line 353e dividing the first block 352 vertically.

In another embodiment, the rotation operation unit 110 may vertically divide a first block 354 to determine second blocks 355a and 355b. The rotation operation unit 110 may determine a direction of performing the rotation operation using the sample values included in the second blocks 355a and 355b, based on the first block 354, and thus may determine that the rotation operation is to be performed on the second block 355a which is a left block in a right direction 355c and the second block 355b which is a right block in a right direction 355d. In this case, the rotation operation unit 110 may determine sample positions at which the rotation operation is started as samples adjacent to a left boundary and a right boundary of the first block 354.

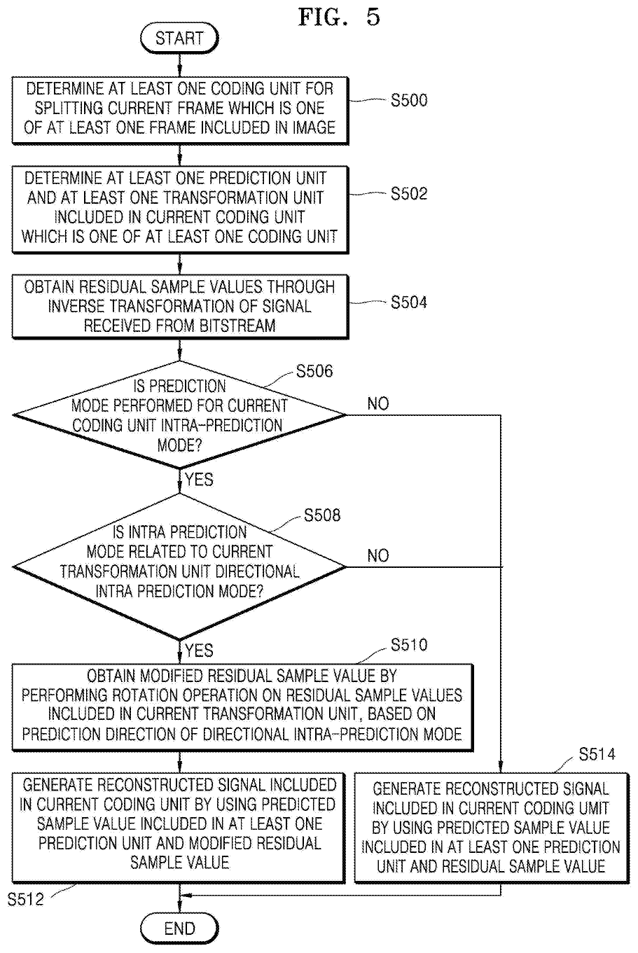

FIG. 4 is a flowchart of a process of performing the rotation operation according to whether a prediction mode related to a current coding unit is an intra-prediction mode, according to an embodiment.

Features of operations S400 to S404 may be substantially the same as those of operations S200 to S204 described above with reference to FIG. 2 and thus a detailed description thereof will be omitted.

In operation S406, the image decoding device 100 may determine whether a prediction mode to be performed based on at least one prediction unit included in a current coding unit is an intra-prediction mode. In an embodiment, the decoder 120 may determine whether inter prediction is to be performed on a data unit (e.g., a sequence, a picture, a largest coding unit, a slice, a slice segment, or the like) which includes the current coding unit. When the data unit including the current coding unit is a data unit on which inter prediction is to be performed, whether inter prediction or intra prediction is to be performed on the current coding unit may be determined. In an embodiment, the image decoding device 100 may determine whether intra prediction is to be performed based on the current coding unit by obtaining, from a bitstream, a flag indicating that a prediction mode related to the current coding unit is the intra prediction mode.

In an embodiment, in operation S408, when it is determined that intra prediction is to be performed on the current coding unit, the rotation operation unit 110 may obtain a modified residual sample value by performing the rotation operation on residual sample values included in a current transformation unit which is one of at least one transformation unit. Features of the rotation operation performed by the rotation operation unit 110 to obtain the modified residual sample value in operation S408 may be substantially the same as those of operation S206 and thus a detailed description thereof is omitted herein.

In operation S410, the decoder 120 of the image decoding device 100 may generate a reconstructed signal included in the current coding unit by using a predicted sample value included in at least one prediction unit and the modified residual sample value. Features of operation S410 may be substantially the same as those of operation S208 of FIG. 2 and thus a detailed description thereof is omitted herein.

In an embodiment, in operation S412, when it is determined that intra prediction is not to be performed on at least one prediction unit included in the current coding unit, the decoder 120 may generate a reconstructed signal included in the current coding unit by using the predicted sample value included in the at least one prediction unit and the residual sample values. That is, the decoder 120 may perform a process of obtaining a reconstructed signal by adding the predicted sample value to residual sample values of a spatial domain, the residual sample values being obtained by inversely transforming information included in the bitstream. In the process of obtaining the reconstructed signal using the residual sample values which are an inverse transformation result and the predicted sample value, various techniques may be employed within a range in which the techniques may be easily implemented those of ordinary skill in the art.

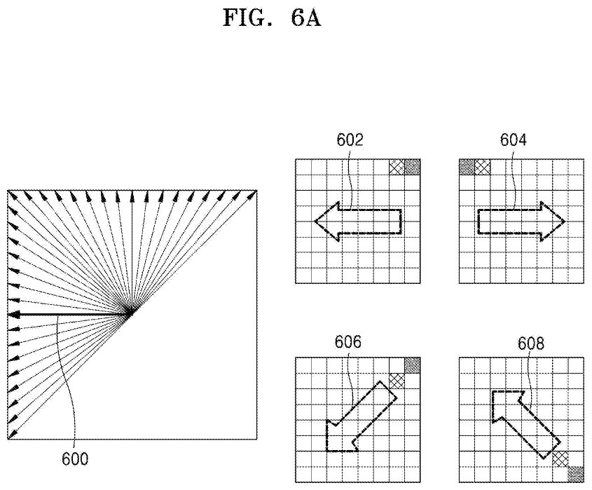

FIG. 5 is a flowchart of a process of performing the rotation operation, based on whether an intra-prediction mode related to at least one prediction unit included in a current coding unit is a directional intra-prediction mode, according to an embodiment.

Features of operations S500 to S506 may be substantially the same as those of operations S400 to S406 described above with reference to FIG. 4 and thus a detailed description thereof will be omitted.

In an embodiment, in operation S508, when a prediction mode related to a current coding unit is an intra prediction mode, the decoder 120 may determine whether an intra prediction mode related to a current transformation unit is the directional intra prediction mode. In an embodiment, when the prediction mode of the current coding unit is the intra prediction mode, at least one transformation unit may be included in each of at least one prediction unit included in the current coding unit. That is, when the current coding unit is related to the intra-prediction mode, a transformation unit cannot overlap a boundary between prediction units and thus all samples included in one transformation unit should be included in the same prediction unit.

In an embodiment, in order to determine whether an intra prediction mode related to a current transformation unit is the directional intra-prediction mode, the decoder 120 may determine whether an intra prediction mode performed for a prediction unit included in the current transformation unit is the directional intra-prediction mode.

In an embodiment, the image decoding device 100 may obtain, from a bitstream, information indicating an intra prediction mode for each of at least one prediction unit among a plurality of intra prediction modes. The decoder 120 may particularly determine an intra prediction mode performed for the prediction unit for each of at least one prediction unit. In an embodiment, examples of an intra prediction mode which may be performed by the image decoding device 100 may include various types of intra prediction modes, such as the directional intra-prediction mode, the non-directional intra-prediction mode (the DC mode or the planar mode), a depth intra prediction mode, a wedge intra prediction mode, etc.

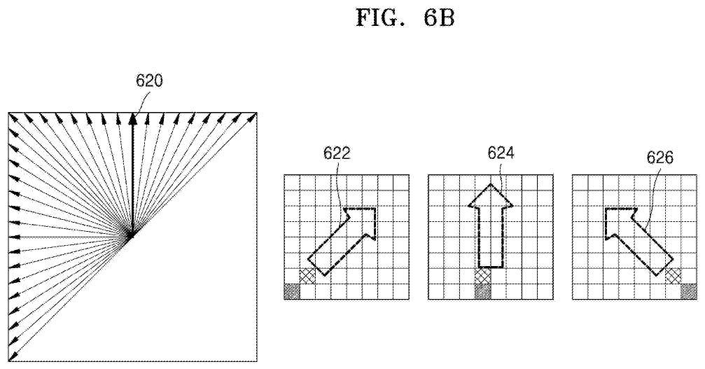

In an embodiment, in operation S510, when the intra prediction mode related to the current transformation unit is the directional intra-prediction mode, the rotation operation unit 110 may obtain a modified residual sample value by performing the rotation operation on residual sample values included in the current transformation unit, based on a prediction direction of the directional intra-prediction mode. A process of obtaining a modified residual sample value by performing the rotation operation based on a prediction direction of the directional intra prediction mode will be described with reference to FIGS. 6A and 6B below.

FIGS. 6A and 6B are diagrams for explaining a method of obtaining a modified residual sample value by performing the rotation operation, based on a prediction direction of a directional intra-prediction mode, according to an embodiment.

In an embodiment, when a prediction mode performed for one of at least one prediction unit is the directional intra prediction mode, the rotation operation unit 110 may determine a rotation-operation performing direction, based on at least one direction including a prediction direction of the directional intra-prediction mode. Referring to FIG. 6A, when a prediction direction of the directional intra-prediction mode of a prediction unit including a current transformation unit is a left direction 600, the rotation operation unit 110 may determine one of a plurality of rotation-operation performance directions 602, 604, 606, 608, etc., including the direction 602 identical to the left direction 600, to be a direction in which the rotation operation unit is to be performed on the current transformation unit.

In an embodiment, the image decoding device 100 may determine in advance a plurality of rotation-operation performance directions corresponding to prediction directions of a plurality of directional intra prediction modes. That is, the decoder 120 may determine a direction identical to a prediction direction, a direction rotated by 180 degrees with respect to the prediction direction, and a direction rotated clockwise or counterclockwise with respect to the prediction direction to be a rotation-operation performance direction.

In another embodiment, a rotation-operation prediction direction of each of at least one transformation unit included in a prediction unit may be determined based on an index indicating the directional intra prediction mode performed for the prediction unit. For example, when a value of an index indicating the directional intra-prediction mode of the prediction unit is N, the rotation operation unit 110 may determine one of directions identical to prediction directions of intra prediction modes corresponding to index values of N−p, N, N+p, N+p+q, etc. to be a rotation-operation performance direction.

Referring to FIG. 6B, when a value of an index indicating a prediction mode of a prediction unit including at least one transformation unit is N and thus the directional intra-prediction mode is performed, one of a direction 622 which is the same as or similar to a prediction direction of a prediction mode having an index of N+p, a direction 624 which is the same as or similar to a prediction direction having an index of N, and a direction 626 which is the same as or similar to a prediction direction having an index of N−p may be determined as a rotation-operation performance direction. That is, the rotation operation unit 110 may determine one of the plurality of directions 622, 624, and 626 determined in advance for each prediction unit as a rotation-operation performing operation of each of at least one transformation unit included in a prediction unit.

Features of operation S512 may be the same as or similar to those of operation S410 described above with reference to FIG. 4 and thus a detailed description thereof will be omitted.

In an embodiment, in operation S514, when it is determined in operation S506 that the prediction mode performed for the current coding unit is not the intra prediction mode or when it is determined in operation S508 that the intra prediction mode related to the current transformation unit is not the directional intra prediction mode, the decoder 120 may generate a reconstructed signal included in the current coding unit by using the predicted sample value included in the at least one prediction unit and the residual sample value. Features of operation S514 may be the same as or similar to those of operation S412 of FIG. 4 and thus a detailed description thereof will be omitted.

In an embodiment, in order to obtain a modified residual sample value, the rotation operation unit 110 may determine a start position and an end position of the rotation operation on the current transformation unit, and obtain a modified residual sample value by performing the rotation operation while changing a rotation angle of coordinates determined by residual sample values at the start position and the end position.

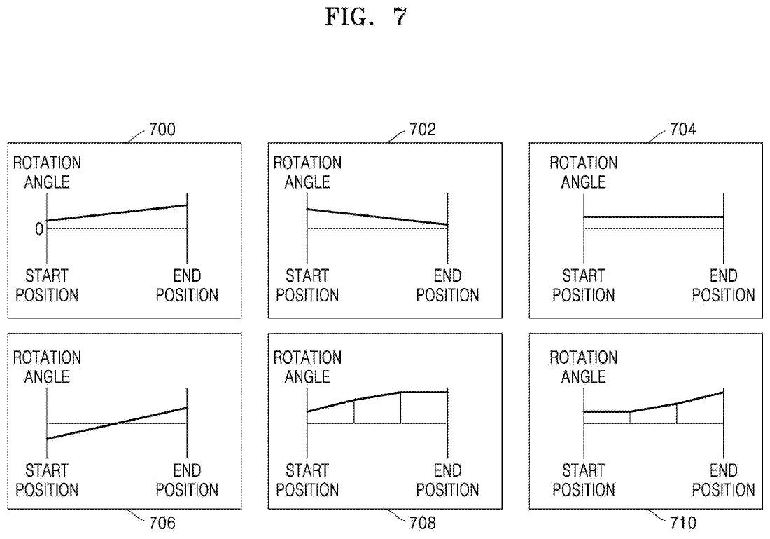

FIG. 7 illustrates changing a rotation angle of coordinates between a start position and an end position of the rotation operation in a block, according to an embodiment.

Referring to FIG. 7, the rotation operation unit 110 may determine a start position and an end position of a rotation operation in a block. The start position and the end position of the rotation operation in the block may be variously determined according to a rotation-operation performance direction. This feature has been described above with reference to various embodiments, including the embodiments of FIGS. 3A, 3B, 3C, and 3D and thus a detailed description thereof will be omitted.

The start position and the end position illustrated in FIG. 7 may be positions of samples adjacent to a boundary in the block, which is determined by a direction in which the rotation operation is performed on the block. In an embodiment, referring to FIG. 3C, when the rotation operation is performed in the left direction 331c, the position of the sample 331a adjacent to the right boundary may be a start position and the rotation operation may be performed to a sample adjacent to the left boundary. Furthermore, the rotation operation unit 110 may perform the rotation operation from the sample 331a adjacent to the right boundary to the same adjacent to the left boundary by changing a rotation angle of coordinates.

In an embodiment, the rotation operation unit 110 may obtain a modified residual sample value by determining a maximum angle and a minimum angle by which coordinates are shifted through the rotation operation, determining a start position and an end position of the rotation operation on a current transformation unit, and performing the rotation operation unit by changing a rotation angle of coordinates determined by residual sample values at the start and end positions to be within a range of the maximum and minimum angles.

In an embodiment, the maximum angle and the minimum angle by which coordinates are shifted through the rotation operation may be angles which are set in advance with respect to data units (e.g., a picture, a slice, a slice segment, a largest coding unit, a coding unit, a prediction unit, a transformation unit, etc.). The rotation operation unit 110 may perform the rotation operation by changing the rotation angle of the coordinates to be within the maximum angle and the minimum angle.

Referring to FIG. 7, the rotation operation unit 110 may perform constantly increasing the rotation angle during performing of the rotation operation unit from the start position to the end position (700), constantly reducing the rotation angle during performing of the rotation operation unit from the start position to the end position (702), maintaining the rotation angle constant during performing of the rotation operation unit from the start position to the end position (704), changing a rotation direction while constantly increasing the rotation angle during performing of the rotation operation unit from the start position to the end position (706), and changing a rate of change of the rotation angle at a predetermined position in a block a certain number of times during performing of the rotation operation unit from the start position to the end position (708 or 710). However, the start position, the end position, and the method of changing a rotation angle which are illustrated in FIG. 7 are merely examples for using various rotation angles of coordinates on a certain block in performing the rotation operation by the image decoding device 100 and thus should not be construed as being limited thereto.

In an embodiment, the image decoding device 100 may obtain information regarding a method of changing a rotation angle, which is to be used for the performing of the rotation operation, for each predetermined data unit (e.g., a picture, a slice, a slice segment, a largest coding unit, a coding unit, a prediction unit, a transformation unit, or the like) from a bitstream, and the rotation operation unit 110 may perform the rotation operation on a block included in each predetermined data unit (e.g., a reference block for determining the start position and the end position of the rotation operation), based on the obtained information.

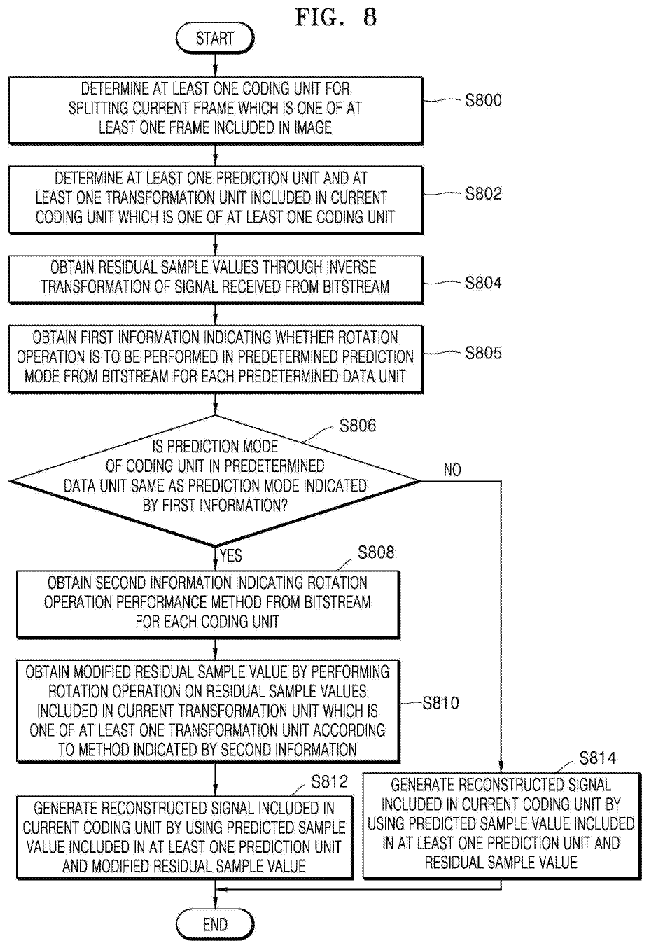

FIG. 8 is a flowchart of a method of performing the rotation operation, based on first information and second information, according to an embodiment.

Features of operations S800 to S804 may be the same as or similar to those of operations S200 to S204 of FIG. 2 and thus a detailed description thereof will be omitted.

In an embodiment, in operation S805, for each predetermined data unit, the image decoding device 100 may obtain first information indicating whether the rotation operation is to be performed in a predetermined prediction mode from a bitstream.

In an embodiment, the image decoding device 100 may obtain the first information indicating whether to perform the rotation operation in the predetermined prediction mode from the bitstream for each predetermined data unit including a current transformation unit, and obtain a modified residual sample value by performing the rotation operation on at least one transformation unit included in the predetermined data unit, based on the first information. In an embodiment, the first information indicating whether to perform the rotation operation in the predetermined prediction mode (e.g., the intra prediction mode, the inter prediction mode, the depth intra prediction mode, or the like) may be obtained from the bitstream for each predetermined data unit. Examples of the predetermined data unit may include various types of data units, including a picture, a slice, a slice segment, a largest coding unit, a coding unit, a prediction unit, a transformation unit, and the like.

In an embodiment, when the first information indicates that the rotation operation is to be performed in the predetermined prediction mode, the image decoding device 100 obtaining the first information from the bitstream for each predetermined data unit may perform the rotation operation in a block included in a coding unit on which prediction is performed in the predetermined prediction mode. For example, the image decoding device 100 may obtain the first information from the bitstream for each slice which is a predetermined data unit. When the first information indicates that the rotation operation is to be performed only when prediction is performed in the intra prediction mode, the rotation operation unit 110 of the image decoding device 100 may determine that the rotation operation is to be performed on a coding unit included in the slice related to the first information only when the coding unit is related to the intra prediction mode and is not to be performed on coding units related to the other prediction modes, including the inter prediction mode.

In an embodiment, in operation S806, the image decoding device 100 may determine whether a prediction mode of a coding unit in the predetermined data unit and the prediction mode indicated by the first information are the same. That is, for each of a plurality of coding units included in the predetermined data unit, the image decoding device 100 may compare the prediction mode, indicated by the first information, in which the rotation operation is to be performed with the prediction mode of each coding unit to determine whether the prediction modes are the same.

In an embodiment, when the prediction mode of the coding unit in the predetermined data unit is the same as the prediction mode indicated by the first information, the image decoding device 100 obtaining the first information may obtain second information indicating a method of performing the rotation for each of coding unit from the bitstream, in operation S808, and may obtain a modified residual sample value by performing the rotation operation on residual sample values included in a current transformation unit which is one of at least one transformation unit according to the method indicated by the second information, in operation S810.

In an embodiment, the image decoding device 100 may obtain the second information indicating a rotation operation performance method from the bitstream for each predetermined data unit, and perform the rotation operation on a block included in each predetermined data unit when the second information indicates that the rotation operation is to be performed. In an embodiment, the image decoding device 100 may obtain the second information from the bitstream for each coding unit which is a predetermined data unit. When the second information indicates that the rotation operation is to be performed, the rotation operation unit 110 may perform the rotation operation on each block (e.g., each transformation unit) in a coding unit for which the second information is obtained.

In an embodiment, rotation operation performance methods indicated by the second information may be classified, based on at least one of a sample position at which the rotation operation is started, an order in which the rotation operation is performed, or an angle of change. That is, the second information may be information indicating at least one of rotation operation performance methods which may be performed according to the above-described various embodiments, and the rotation operation performance methods indicated by the second information may include a plurality of predetermined methods. That is, the second information may indicate one of a plurality of rotation operation performance methods, including at least one of the sample position at which the rotation operation is started, the order in which the rotation operation is performed, or the angle of change, and the rotation operation unit 110 may perform the rotation operation according to the rotation operation performance method indicated by the second information.

In an embodiment, the second information may indicate one of rotation operation performance methods. In another embodiment, the second information may be information indicating whether or not the rotation operation is to be performed on a data unit for which the second information is obtained. That is, the second information may be determined to include various information as shown in Table 1 below. However, Table 2 below is merely an example of indicating that whether the rotation operation is to be performed may be determined based on the second information, and a method of performing the rotation operation may be determined according to the second information when the rotation operation is to be performed. Thus, features of the second information should not be construed as being limited to Table 2 below. The rotation operation unit 110 may perform the rotation operation, based on various rotation operation performing modes indicated by the second information.

TABLE 1

| TYPE 1 OF | | TYPE 2 OF | |
|---|---|---|---|
| SECOND INFORMATION | | SECOND INFORMATION | |
| 00B | PERFORM ROTATION | OB | PERFORM ROTATION |
| | OPERATION: X | | OPERATION: X |
| 01B | PERFORM ROTATION | 1B | PERFORM ROTATION |
| | OPERATION IN | | OPERATION: 0 |
| | FIRST MODE | | |
| 10B | PERFORM ROTATION | | |
| | OPERATION IN | | |
| | SECOND MODE | | |
| 11B | PERFORM ROTATION | | |
| | OPERATION IN | | |
| | THIRD MODE | | |

In an embodiment, in operation S812, the image decoding device 100 may produce a reconstructed signal included in a current coding unit by using a predicted sample value included in at least one prediction unit and the modified residual sample value. Features of operation S812 may be the same as or similar to those of operation S208 of FIG. 2 described above and thus a detailed description thereof will be omitted.

In operation S806, when the prediction mode, indicated by the first information, in which the rotation operation is performed is different from the prediction mode performed for the current coding unit, the image decoding device 100 may obtain the modified residual sample value by obtaining the second information indicating the method of performing the rotation operation on the current coding unit for each of at least one coding unit from the bitstream, and thus, the producing of the reconstructed signal may be omitted. Accordingly, in operation S814, the image decoding device 100 may produce a reconstructed signal included in the current coding unit by using the predicted sample value included in the at least one prediction unit and the residual sample values. Features of operation S814 may be the same as or similar to those of operation S412 of FIG. 4 described above and thus a detailed description thereof will be omitted.

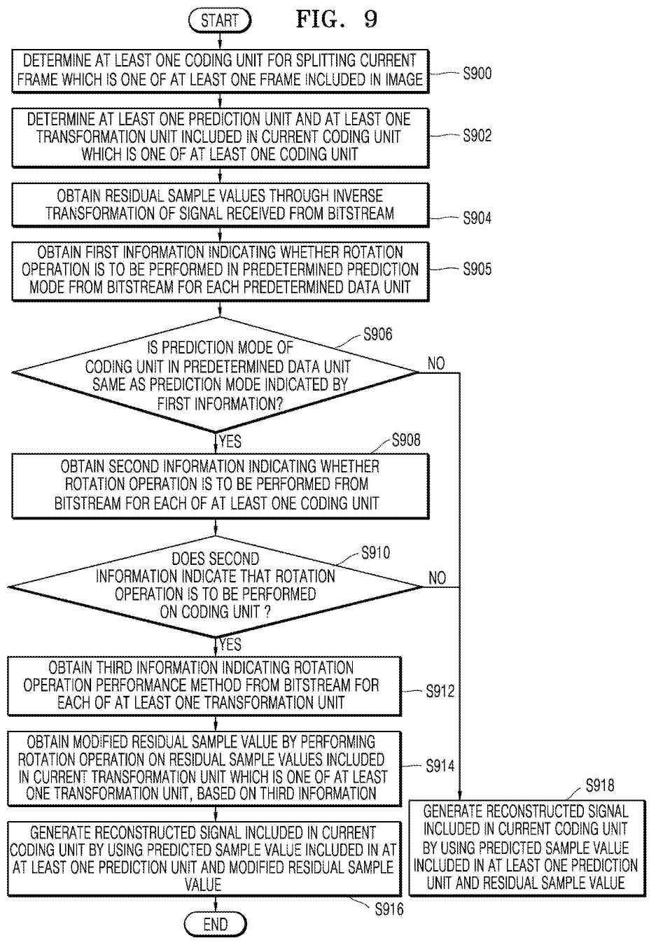

FIG. 9 is a flowchart of a method of performing the rotation operation, based on first information, second information, and third information, according to an embodiment.

Features of operations S900 to S906 may be the same as or similar to those of operations S800 to S806 of FIG. 8 and thus a detailed description thereof will be omitted.

In an embodiment, in operation S908, when a prediction mode of a coding unit in a predetermined data unit is the same as a prediction mode indicated by first information, the image decoding device 100 may obtain second information indicating whether the rotation operation is to be performed on a current coding unit from a bitstream for each of at least one coding unit when the prediction mode, indicated by the first information, in which the rotation operation is to be performed is the same as a prediction mode performed for the current coding unit. When the second information indicates that the rotation operation is to be performed on the current coding unit, the rotation operation unit 110 may perform the rotation operation on the current coding unit. That is, in this case, the second information may correspond to type 2 shown in Table 1 above, and may indicate only whether the rotation operation is to be performed on the current coding unit but does not indicate a specific rotation operation performance method.

In operation S910, the image decoding device 100 may determine whether the second information indicates whether the rotation operation is to be performed on the coding unit.

In an embodiment, in operation S912, when the second information indicates that the rotation operation is to be performed on the current coding unit, the image decoding device 100 may obtain third information indicating a rotation operation performance method to be performed on the current coding unit from the bitstream for each of at least one transformation unit. The third information may be information indicating the rotation operation performance method to be performed on each of the at least one transformation unit. The rotation operation performance method indicated by the third information may be configured based on at least one of a sample position at which the rotation operation is performed, an order in which the rotation operation is performed, or an angle of change. That is, the third information may indicate one of a plurality of rotation operation performance methods which may be configured based on at least one of the sample position at which the rotation operation is started, the order in which the rotation operation is performed, or the angle of change, and the rotation operation unit 110 may perform the rotation operation according to the rotation operation performance method indicated by the third information.

In another embodiment, in the image decoding device 100, when the prediction mode, indicated by the first information, in which the rotation operation is to be performed is different from the prediction mode performed for the current coding unit, the obtaining of the second information indicating whether the rotation operation is to be performed on the current coding unit for each of the at least one coding unit from the bitstream may be skipped.

For example, when the first information obtained from the bitstream for each slice which is a predetermined data unit indicates that the rotation operation is to be performed only in the intra prediction mode, the image decoding device 100 may determine whether coding units included in the slice are related to the intra prediction mode. When it is determined that some of the coding units in the slice are not predicted using the intra prediction mode, the image decoding device 100 may not obtain the second information for the coding units, which are not predicted using the intra prediction mode, from the bitstream. Accordingly, it may be understood that the rotation operation is not to be performed on the coding units for which the second information is not obtained, and the obtaining of the third information for each transformation unit included in these coding units from the bitstream may also be skipped, thereby efficiently performing bitstream bandwidth management.

In an embodiment, in operation S914, the rotation operation unit 110 of the image decoding device 100 may obtain a modified residual sample value by performing the rotation operation on residual sample values included in a current transformation unit which is one of at least one transformation unit, based on the third information. In the case of a coding unit on which the rotation operation is determined to be performed based on the second information, the third information may be obtained for each transformation unit from the bitstream, and a modified residual sample value may be obtained by performing the rotation operation on each transformation unit, based on the rotation operation performance method indicated by the third information.

In operation S916, the image decoding device 100 may produce a reconstructed signal included in a current coding unit by using a predicted sample value included in at least one prediction unit and the modified residual sample value. Features of operation S916 may be the same as or similar to those of operation S208 of FIG. 2 described above and thus a detailed description thereof will be omitted.

In an embodiment, in operation S918, the image decoding device 100 may produce a reconstructed signal included in the current coding unit by using a predicted sample value included in at least one prediction unit included in the current coding unit and the residual sample values, when it is determined in S906 that the prediction mode of the current coding unit included in the predetermined data unit is different from the prediction mode indicated by the first information or when it is determined in S910 that the second information indicates that the rotation operation is not to be performed on the current coding unit.

Features of an image encoding device 150 that performs an encoding process in the same or similar manner to various image decoding methods according to embodiments performed by the image decoding device 100 will be described below.

FIG. 1B is a block diagram of the image encoding device 150 for performing an image encoding process of performing the rotation operation to produce a modified residual sample value, according to an embodiment.

In an embodiment, the an image encoding device 150 may include a rotation operation unit 160 configured to obtain a modified residual sample value by performing the rotation operation on a residual sample value corresponding to the difference between an original sample value and a predicted sample value; and an encoder 170 configured to determine at least one coding unit for splitting a current frame which is one of at least one frame included in an image, determine at least one prediction unit and at least one transformation unit included in a current coding unit which is one of at least one coding unit, and produces a bitstream by converting a modified residual sample value obtained by performing the rotation operation on a residual sample value. Operations of the image encoding device 150 will be described in detail with respect to various embodiments below.

In an embodiment, the encoder 170 may encode the image by using a result of the rotation operation performed by the rotation operation unit 160. Furthermore, the encoder 170, which is a hardware component such as a processor or a CPU, may perform the rotation operation performed by the rotation operation unit 110. Encoding processes which are not described as particularly performed by the rotation operation unit 160 in various embodiments described below may be interpreted as being performed by the encoder 170.

In an embodiment, the encoder 170 of the image encoding device 150 may determine at least one coding unit for splitting a current frame which is one of at least one frame included in an image. Furthermore, in operation S202, when at least one coding unit is determined, the encoder 170 may determine at least one prediction unit and at least one transformation unit included in a current coding unit which is one of the at least one coding unit.

In an embodiment, the encoder 170 may split a current frame, which is one of frames of the image, into various data units. In an embodiment, the encoder 170 may perform an image encoding process using various types of data units, such as sequences, frames, slices, slice segments, largest coding units, coding units, prediction units, transformation units, and the like, to encode the image, and produce a bitstream containing information related to a corresponding data unit for each of the data units. Forms of various data units according to various embodiments, which may be used by the encoder 170, will be described with reference to FIG. 10 and other drawings below.

In an embodiment, the encoder 170 may produce a bitstream including a result of performing frequency transformation on residual sample values according to an embodiment.

In an embodiment, the encoder 170 may determine a transformation unit by splitting a coding unit, which is determined according to a tree structure, according to the quad tree structure. For frequency transformation of each largest coding unit, the encoder 170 may transform each coding unit based on transformation units by reading information regarding the transformation units for each coding unit according to the tree structure. In an embodiment, the encoder 170 may convert components of a spatial domain into components of a frequency domain through a transform process. In this case, the encoder 170 may use various core transformation methods and various secondary transformation methods. For example, the encoder 170 may use a discrete sine transform (DST) or a discrete cosine transform (DCT) as a core transformation scheme to obtain a residual sample value. Furthermore, a transformation process associated with a method such as a non-separable secondary transform may be performed as a secondary transformation process to generate an input value for core transformation during an image reconstruction process.

In an embodiment, the rotation operation unit 160 may obtain a modified residual sample value by performing the rotation operation on residual sample values included in a current transformation unit which is one of the at least one transformation unit.

In an embodiment, the rotation operation unit 160 may obtain a modified residual signal by performing the rotation operation, based on at least one of a position of a sample of a current transformation unit at which the rotation operation is started, an order of performing the rotation operation on the current transformation unit, or an angle by which coordinates are shifted through the rotation operation.

In an embodiment, the rotation operation performed by the rotation operation unit 160 may be performed by a process similar to or opposite to the rotation operation performed by the rotation operation unit 110 of the image decoding device 100 and thus a detailed description thereof will be omitted. That is, a rotation operation process performed by the image encoding device 150 may include an operation opposite to that of a rotation operation process performed by the image decoding device 100 described above. For example, a sample position at which the rotation operation is started by the image encoding device 150, an order in which the rotation operation is performed, and an angle by which coordinates are rotated by the rotation operation may be respectively opposite to the sample position at which the rotation operation is started by the image decoding device 100, the order in which the rotation operation is performed, and the angle by which coordinates are rotated by the rotation operation.

FIG. 3A is a diagram illustrating a direction in which the rotation operation is performed by the image encoding device 150, according to an embodiment.

In an embodiment, the rotation operation unit 160 may determine an order in which the rotation operation is to be performed within a current transformation unit. Referring to FIG. 3A, the current transformation unit 300 may include values of 8×8 samples, and the rotation operation unit 160 may determine a sample adjacent to the left side of the first residual sample 301 to be the second residual sample 302. The rotation operation unit 160 may perform the rotation operation by using a sample value of the first residual sample 301 and a sample value of the second residual sample 302. After the rotation operation using the first residual sample 301 and the second residual sample 302 is completed, the rotation operation may be performed using samples at different positions in a predetermined order. Features of the operation of the image encoding device 150 illustrated in FIG. 3A may be similar or reverse to those of the image decoding device 100 described above and thus a detailed description thereof will be omitted.

FIG. 3B illustrates a process of performing the rotation operation on a current transformation unit by using a predetermined angle, the process being performed by the image encoding device 150, according to an embodiment.

In an embodiment, the rotation operation unit 160 may rotate coordinates consisting of a first residual sample value and a second residual sample value by an angle by which coordinates are shifted through the rotation operation. Referring to FIG. 3B, the coordinates 313 consisting of the sample value a1 of the first residual sample 311 and the sample value a2 of the second residual sample 312 which are included in the current transformation unit 310 are rotated by the predetermined angle θ as a result of performing the rotation operation and thus are shifted to the new coordinates 314. Thus, coordinates are shifted from a1, which is a first residual sample, and a2, which is a second residual sample value, to a1′and a2′, respectively. That is, the coordinates (a1, a2) may be shifted into (a1′, a2′) by the rotation operation and used later in a decoding process.

In an embodiment, in the image encoding device 150, an angle by which coordinates are shifted may be determined based on at least one of an intra prediction mode performed for at least one prediction unit included in a current coding unit, a partition mode for determining at least one prediction unit, or a size of a block on which the operation is performed.

In an embodiment, the rotation operation unit 160 may determine an angle by which coordinates consisting of values of samples in a transformation unit included in a current coding unit are shifted, based on an intra prediction mode related to at least one prediction unit included in the current coding unit.

In an embodiment, the image encoding device 150 may produce a bitstream including index information indicating an intra prediction mode for determining a direction in which prediction is performed.

In an embodiment, the rotation operation unit 160 may rotate coordinates consisting of values of samples of a current transformation unit by θ1 when at least one prediction unit is related to the directional intra-prediction mode among intra prediction modes, and may rotate the coordinates consisting of the values of the samples of the current transformation unit by θ2 when the at least one prediction unit is related to the non-directional intra-prediction mode (e.g., the DC mode or the planar mode) among the intra prediction modes. In detail, the rotation operation unit 160 may differently set an angle by which coordinates are shifted according to a prediction direction in the directional intra prediction mode. However, features of an angle by which coordinates are shifted according to the type of intra prediction mode described above should not be construed as being limited to θ1 and θ2 described above, and angles variously classified for each intra prediction mode according to a certain criterion may be used by the rotation operation unit 160.

In an embodiment, the rotation operation unit 110 may determine an angle by which coordinates consisting of values of samples in a transformation unit included in a current coding unit are shifted, based on a partition mode of the current coding unit. Furthermore, in an embodiment, the rotation operation unit 160 may use a width or height of a partition included in a current coding unit to determine an angle by which coordinates consisting of values of samples included in a current transformation unit are rotated to change the coordinates. Features of a method of performing the rotation operation using at least one of a partition mode, at least one of the width or height of a partition by the rotation operation unit 160 of the image encoding device 150 may be similar to or reverse to the operations of the rotation operation unit 110 of the image encoding device 150 and thus a detailed description thereof will be omitted.

FIG. 3C illustrates various positions at which the rotation operation may be performed, according to an embodiment, and FIG. 3D illustrates various examples of directions in which the rotation operation may be performed by the image encoding device 50, according to an embodiment. The encoder 170 of the image encoding device 150 may determine one of a plurality of rotation-operation performance direction to be an optimum rotation-operation performance direction through rate distortion optimization. Features of the image encoding device 150 related to FIGS. 3C and 3D may be similar or opposite to those of the operations performed by the image decoding device 100 described above with reference to FIGS. 3C and 3D and thus a detailed descriptions thereof will be omitted.

In an embodiment, the image encoding device 150 may perform a process similar or opposite to the rotation operation process performed by the image decoding device 100 describe above with reference to FIG. 4 so as to perform the rotation operation according to whether a prediction mode related to a current coding unit is an intra-prediction mode.

In an embodiment, the image encoding device 150 may determine whether a prediction mode to be performed based on at least one prediction unit included in a current coding unit is the intra-prediction mode. In an embodiment, the encoder 170 may determine whether inter prediction is to be performed on a data unit (e.g., a sequence, a picture, a largest coding unit, a slice, a slice segment, or the like) which includes the current coding unit. When the data unit including the current coding unit is a data unit on which inter prediction is to be performed, whether inter prediction or intra prediction is to be performed on the current coding unit may be determined.

In an embodiment, when it is determined that intra prediction is to be performed on the current coding unit, the rotation operation unit 160 may obtain a residual sample value corresponding to the difference between a predicted sample value included in at least one prediction unit and an original sample value. The encoder 170 may obtain a modified residual sample value by performing the rotation operation on residual sample values included in a current transformation unit which is one of at least one transformation unit.

In an embodiment, a process similar or opposite to the rotation operation process performed by the image decoding device 100 describe above with reference to FIG. 5 may be performed to perform the rotation operation, based on whether an intra-prediction mode related to at least one prediction unit included in a current coding unit is a directional intra-prediction mode.

In an embodiment, when the prediction mode related to the current coding unit is an intra-prediction mode, the encoder 170 may determine whether an intra-prediction mode related to a current transformation unit is the directional intra-prediction mode. In an embodiment, when the prediction mode of the current coding unit is the intra-prediction mode, at least one transformation unit may be included in each of at least one prediction unit included in the current coding unit. That is, when the current coding unit is related to the intra-prediction mode, a transformation unit cannot overlap a boundary between prediction units and thus all samples included in one transformation unit should be included in the same prediction unit. The determining of whether the intra-prediction mode related to the current transformation unit is the directional intra-prediction mode may be substantially the same as the operation performed in operation S508 by the image decoding device 100 and thus a detailed description thereof will be omitted.

In an embodiment, when the intra-prediction mode related to the current transformation unit is the directional intra-prediction mode, the rotation operation unit 160 may obtain a modified residual sample value by performing the rotation operation on residual sample values included in the current transformation unit, based on a prediction direction of the directional intra-prediction mode. The encoder 170 of the image encoding device 150 may determine one of a plurality of rotation-operation performance direction to be an optimum rotation-operation performance direction through rate distortion optimization. The obtaining of the modified residual sample value based on the prediction direction of the directional intra-prediction mode by the image encoding device 150 may be similar or opposite to an operation performed by the image decoding device 100 described above with reference to FIGS. 6A and 6B and thus a detailed description thereof will be omitted. In an embodiment, the image encoding device 150 may produce a bitstream including the modified residual sample value and transmit the bitstream to a decoding side.

In an embodiment, when it is determined that a prediction mode performed for the current coding unit is not the intra-prediction mode or the intra-prediction mode related to the current transformation unit is not the directional intra-prediction mode, the encoder 170 may produce a bitstream including a residual sample value corresponding to the difference between an original sample value and a predicted sample value and transmit the bitstream to the decoding side without performing the rotation operation on the current transformation unit.

In an embodiment, in order to obtain the modified residual sample value, the rotation operation unit 160 may determine a start position and an end position of the rotation operation on the current transformation unit, and obtain the modified residual sample value by performing the rotation operation while changing a rotation angle of coordinates determined by residual sample values at the start position and the end position.

FIG. 7 illustrates changing a rotation angle of coordinates between a start position and an end position of the rotation operation in a block, according to an embodiment. In this regard, a process of changing an angle to be used by the image encoding device 150 during performing of the rotation operation may be similar or opposite to the operation of the image decoding device 100 of FIG. 7 and thus a detailed description thereof will be omitted.

In an embodiment, in order to perform the rotation operation based on first information and second information, the image encoding device 150 may perform an operation similar to opposite to the operation performed by the image decoding device 100 described above with reference to FIG. 8.

In an embodiment, the image encoding device 150 may produce a bitstream including first information indicating whether the rotation operation is to be performed on each predetermined data unit in a predetermined prediction mode.

In an embodiment, the image encoding device 150 may produce a bitstream including first information indicating whether the rotation operation is to be performed on each predetermined data unit including a current transformation unit in a predetermined prediction mode, and obtain a modified residual sample value by performing the rotation operation on at least one transformation unit included in each predetermined data unit. In an embodiment, a bitstream including the first information indicating whether to perform the rotation operation in the predetermined prediction mode (e.g., the intra prediction mode, the inter prediction mode, the depth intra prediction mode, or the like) may be produced for each predetermined data unit. Examples of the predetermined data unit may include various types of data units, including a picture, a slice, a slice segment, a largest coding unit, a coding unit, a prediction unit, a transformation unit, and the like.

In an embodiment, when it is indicated that the rotation operation is to be performed in the predetermined prediction mode, the image encoding device 150 may perform the rotation operation on a block included in a coding unit on which prediction is performed in the predetermined prediction mode. For example, when it is determined that the rotation operation is to be performed only when prediction is performed in the intra-prediction mode, the image encoding device 150 may produce a bitstream including the first information for each slice which is a predetermined data unit, and the rotation operation unit 160 may determine that the rotation operation is to be performed on a coding unit included in a slice related to the first information only when the coding unit is related to the intra-prediction mode and is not to be performed on coding units related to the other prediction modes, including the inter-prediction mode.

In an embodiment, the image encoding device 150 may determine whether a prediction mode of a coding unit in the predetermined data unit is the same as a prediction mode determined in which the rotation operation is to be performed. That is, for a plurality of coding units included in the predetermined data unit, the image encoding device 150 may compare a prediction mode determined in which the rotation operation is to be performed with the prediction mode of each coding unit to determine whether the prediction modes are the same.

In an embodiment, when a prediction mode determined in which the rotation operation is to be performed is the same as the prediction mode indicated by the first information, the image encoding device 150 may produce a bitstream including second information indicating a rotation operation performance method for each coding unit, and obtain a modified residual sample value by performing residual sample values included in a current transformation unit which is one of at least one transformation unit according to the rotation operation performance method.

In an embodiment, the image encoding device 150 may produce a bitstream including the second information indicating the rotation operation performance method for each predetermined data unit, and perform the rotation operation on a block included in each predetermined data unit according to a method when it is determined that the rotation operation is to be performed according to the method.

In an embodiment, rotation operation performance methods indicated by the second information may be classified, based on at least one of a sample position at which the rotation operation is started, an order in which the rotation operation is performed, or an angle of change. The rotation operation performance methods which may be indicated by the second information have been described above with respect to various embodiments and thus a detailed description thereof will be omitted.

In an embodiment, the second information may indicate one of rotation operation performance methods. In another embodiment, the second information may be information indicating whether or not the rotation operation is to be performed on a data unit for which the second information is obtained. That is, the second information may be determined to include various information as shown in Table 1 below.

In an embodiment, the image encoding device 150 may produce a bitstream including a modified residual sample value when the rotation operation is performed, and produce a bitstream including a residual sample value when the rotation operation is not performed.

In an embodiment, the image encoding device 150 may perform an operation similar or opposite to the operation of the image decoding device 100 described above with reference to FIG. 9 so as to perform the rotation operation based on the first information, the second information, and the third information.

In an embodiment, the image encoding device 150 may produce a bitstream including second information indicating whether to perform the rotation operation on a current coding unit for each of at least one coding unit, when a prediction mode of a coding unit in a predetermined data unit and a prediction mode determined in which the rotation operation is to be performed are the same and the prediction mode indicated in which the rotation operation is to be performed and a prediction mode performed for the current coding unit are the same. When it is determined that the rotation operation is to be performed on a current coding unit, the rotation operation unit 160 may perform the rotation operation on the current coding unit. That is, in this case, the second information included in the bitstream may correspond to type 2 shown in Table 1 above, and may indicate only whether the rotation operation is to be performed on a current coding unit but does not indicate a specific rotation operation performance method.

In an embodiment, the image encoding device 150 may produce a bitstream including second information indicating that the rotation operation is to be performed on a coding unit.

In an embodiment, when it is determined that the rotation operation is to be performed on the current coding unit, the image encoding device 150 may produce a bitstream including third information indicating a rotation operation performance method on the current coding unit for each of at least one transformation unit.

The third information may be information indicating the rotation operation performance method to be performed on each of the at least one transformation unit. The rotation operation performance method indicated by the third information may be configured based on at least one of a sample position at which the rotation operation is performed, an order in which the rotation operation is performed, or an angle of change. That is, the third information may indicate one of a plurality of rotation operation performance methods which may be configured based on at least one of the sample position at which the rotation operation is started, the order in which the rotation operation is performed, or the angle of change, and the rotation operation unit 160 may perform the rotation operation according to the rotation operation performance method indicated by the third information.

In another embodiment, in the image encoding device 150, when the prediction mode indicated in which the rotation operation is to be performed is different from the prediction mode performed for the current coding unit, the producing of the bitstream including second information indicating whether the rotation operation is to be performed on the current coding unit for each of the at least one coding unit may be skipped.

For example, when it is indicated that the rotation operation is to be performed only when a prediction mode for a predetermined data unit is an intra-prediction mode, the image encoding device 150 may determine whether coding units included in the predetermined data unit are related to the intra-prediction mode. When it is determined that some of coding units in a slice are not predicted using the intra -prediction mode, the image decoding device 100 may not produce second information for the coding units, which are not predicted using the intra-prediction mode, from the bitstream. Accordingly, it may be understood that the rotation operation is not to be performed on these coding units and a process of producing a bitstream including third information for each transformation unit included in these coding units may also be skipped, thereby efficiently performing bitstream bandwidth management.

In an embodiment, the rotation operation unit 160 of the image encoding device 150 may obtain a modified residual sample value by performing the rotation operation on residual sample values included in a current transformation unit which is one of at least one transformation unit. In the case of a coding unit determined in which the rotation operation is to be performed, a bitstream including the third information may be produced for each transformation unit, and a modified residual sample value may be obtained by performing the rotation operation on each transformation unit, based on a rotation operation performance method related to the third information.

In an embodiment, the image encoding device 150 may generate a bitstream including the modified residual sample value.

In an embodiment, when a prediction mode of a current coding unit included in a predetermined data unit is different from a prediction mode determined in which the rotation operation is to be performed or when the second information does not indicate that the rotation operation is to be performed on the current coding unit, the image encoding device 150 may generate a bitstream including a residual sample value corresponding to the difference between a predicted sample value included in at least one prediction unit included in the current coding unit and an original sample value.

Hereinafter, a method of determining a data unit that may be used while the image decoding device 100 according to an embodiment decodes an image will be described with reference to FIGS. 10 through 23. Operations of the image encoding device 150 may be similar to or the reverse of various embodiments of operations of the image decoding device 100 described below.

FIG. 10 illustrates a process, performed by the image decoding device 100, of determining at least one coding unit by splitting a current coding unit, according to an embodiment.

According to an embodiment, the image decoding device 100 may determine a shape of a coding unit by using block shape information, and may determine a splitting method of the coding unit by using split shape information. That is, a coding unit splitting method indicated by the split shape information may be determined based on a block shape indicated by the block shape information used by the image decoding device 100.

According to an embodiment, the image decoding device 100 may use the block shape information indicating that the current coding unit has a square shape. For example, the image decoding device 100 may determine whether not to split a square coding unit, whether to vertically split the square coding unit, whether to horizontally split the square coding unit, or whether to split the square coding unit into four coding units, based on the split shape information. Referring to FIG. 10, when the block shape information of a current coding unit 1000 indicates a square shape, the decoder 120 may determine that a coding unit 1010a having the same size as the current coding unit 1000 is not split, based on the split shape information indicating not to perform splitting, or may determine coding units 1010b, 1010c, or 1010d split based on the split shape information indicating a predetermined splitting method.

Referring to FIG. 10, according to an embodiment, the image decoding device 100 may determine two coding units 1010b obtained by splitting the current coding unit 1000 in a vertical direction, based on the split shape information indicating to perform splitting in a vertical direction. The image decoding device 100 may determine two coding units 1010c obtained by splitting the current coding unit 1000 in a horizontal direction, based on the split shape information indicating to perform splitting in a horizontal direction. The image decoding device 100 may determine four coding units 1010d obtained by splitting the current coding unit 1000 in vertical and horizontal directions, based on the split shape information indicating to perform splitting in vertical and horizontal directions. However, splitting methods of the square coding unit are not limited to the above-described methods, and the split shape information may indicate various methods. Predetermined splitting methods of splitting the square coding unit will be described in detail below in relation to various embodiments.

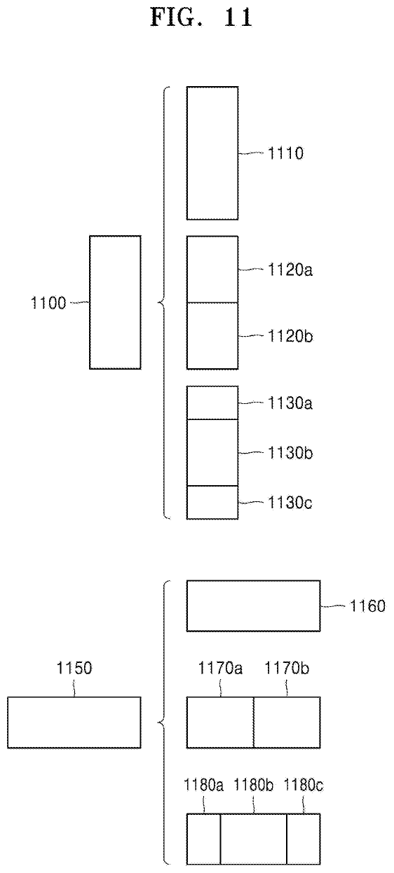

FIG. 11 illustrates a process, performed by the image decoding device 100, of determining at least one coding unit by splitting a non-square coding unit, according to an embodiment.

According to an embodiment, the image decoding device 100 may use block shape information indicating that a current coding unit has a non-square shape. The image decoding device 100 may determine whether not to split the non-square current coding unit or whether to split the non-square current coding unit by using a predetermined splitting method, based on split shape information. Referring to FIG. 11, when the block shape information of a current coding unit 1100 or 1150 indicates a non-square shape, the image decoding device 100 may determine that a coding unit 1110 or 1160 having the same size as the current coding unit 1100 or 1150 is not split, based on the split shape information indicating not to perform splitting, or determine coding units 1120a and 1120b, 1130a to 1130c, 1170a and 1170b, or 1180a to 1180c split based on the split shape information indicating a predetermined splitting method. Predetermined splitting methods of splitting a non-square coding unit will be described in detail below in relation to various embodiments.

According to an embodiment, the image decoding device 100 may determine a splitting method of a coding unit by using the split shape information and, in this case, the split shape information may indicate the number of one or more coding units generated by splitting a coding unit. Referring to FIG. 11, when the split shape information indicates to split the current coding unit 1100 or 1150 into two coding units, the image decoding device 100 may determine two coding units 1120a and 1120b, or 1170a and 1170b included in the current coding unit 1100 or 1150, by splitting the current coding unit 1100 or 1150 based on the split shape information.

According to an embodiment, when the image decoding device 100 splits the non-square current coding unit 1100 or 1150 based on the split shape information, the location of a long side of the non-square current coding unit 1100 or 1150 may be considered. For example, the image decoding device 100 may determine a plurality of coding units by dividing a long side of the current coding unit 1100 or 1150, in consideration of the shape of the current coding unit 1100 or 1150.

According to an embodiment, when the split shape information indicates to split a coding unit into an odd number of blocks, the image decoding device 100 may determine an odd number of coding units included in the current coding unit 1100 or 1150. For example, when the split shape information indicates to split the current coding unit 1100 or 1150 into three coding units, the image decoding device 100 may split the current coding unit 1100 or 1150 into three coding units 1130a, 1130b, and 1130c, or 1180a, 1180b, and 1180c. According to an embodiment, the image decoding device 100 may determine an odd number of coding units included in the current coding unit 1100 or 1150, and not all the determined coding units may have the same size. For example, a predetermined coding unit 1130b or 1180b from among the determined odd number of coding units 1130a, 1130b, and 1130c, or 1180a, 1180b, and 1180c may have a size different from the size of the other coding units 1130a and 1130c, or 1180a and 1180c. That is, coding units which may be determined by splitting the current coding unit 1100 or 1150 may have multiple sizes and, in some cases, all of the odd number of coding units 1130a, 1130b, and 1130c, or 1180a, 1180b, and 1180c may have different sizes.

According to an embodiment, when the split shape information indicates to split a coding unit into an odd number of blocks, the image decoding device 100 may determine an odd number of coding units included in the current coding unit 1100 or 1150, and may put a predetermined restriction on at least one coding unit from among the odd number of coding units generated by splitting the current coding unit 1100 or 1150. Referring to FIG. 11, the image decoding device 100 may allow a decoding method of the coding unit 1130b or 1180b to be different from that of the other coding units 1130a and 1130c, or 1180a and 1180c, wherein the coding unit 1130b or 1180b is at a center location from among the three coding units 1130a, 1130b, and 1130c, or 1180a, 1180b, and 1180c generated by splitting the current coding unit 1100 or 1150. For example, the image decoding device 100 may restrict the coding unit 1130b or 1180b at the center location to be no longer split or to be split only a predetermined number of times, unlike the other coding units 1130a and 1130c, or 1180a and 1180c.

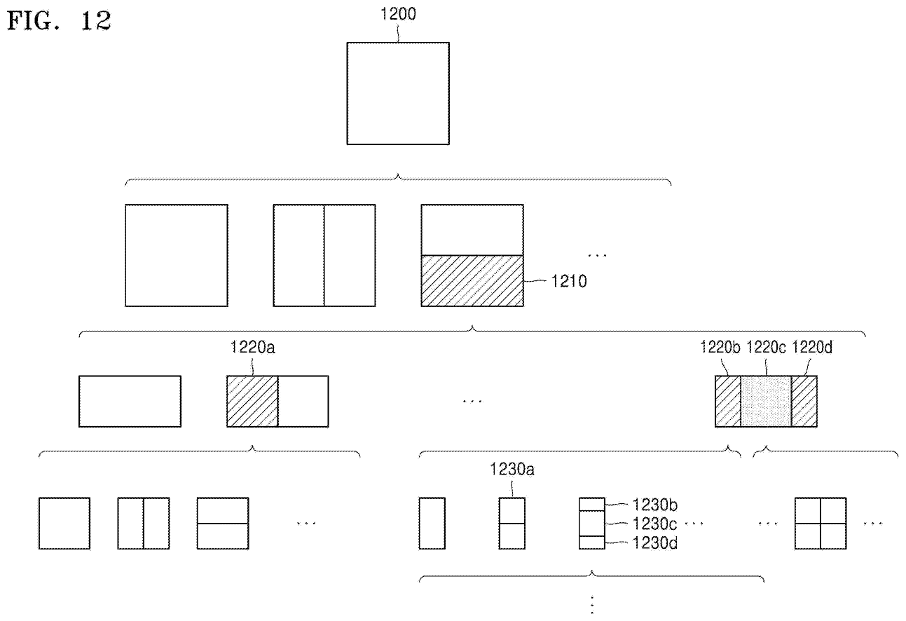

FIG. 12 illustrates a process, performed by the image decoding device 100, of splitting a coding unit based on at least one of block shape information and split shape information, according to an embodiment.

According to an embodiment, the image decoding device 100 may determine to split or not to split a square first coding unit 1200 into coding units, based on at least one of the block shape information and the split shape information. According to an embodiment, when the split shape information indicates to split the first coding unit 1200 in a horizontal direction, the image decoding device 100 may determine a second coding unit 1210 by splitting the first coding unit 1200 in a horizontal direction. A first coding unit, a second coding unit, and a third coding unit used according to an embodiment are terms used to understand a relation before and after splitting a coding unit. For example, a second coding unit may be determined by splitting a first coding unit, and a third coding unit may be determined by splitting the second coding unit. It will be understood that the structure of the first coding unit, the second coding unit, and the third coding unit follows the above descriptions.

According to an embodiment, the image decoding device 100 may determine to split or not to split the determined second coding unit 1210 into coding units, based on at least one of the block shape information and the split shape information. Referring to FIG. 12, the image decoding device 100 may or may not split the non-square second coding unit 1210, which is determined by splitting the first coding unit 1200, into one or more third coding units 1220a, or 1220b, 1220c, and 1220d based on at least one of the block shape information and the split shape information. The image decoding device 100 may obtain at least one of the block shape information and the split shape information, and determine a plurality of various-shaped second coding units (e.g., 1210) by splitting the first coding unit 1200, based on the obtained at least one of the block shape information and the split shape information, and the second coding unit 1210 may be split by using the splitting method of the first coding unit 1200, based on at least one of the block shape information and the split shape information. According to an embodiment, when the first coding unit 1200 is split into the second coding units 1210 based on at least one of the block shape information and the split shape information of the first coding unit 1200, the second coding unit 1210 may also be split into the third coding units 1220a, or 1220b, 1220c, and 1220d based on at least one of the block shape information and the split shape information of the second coding unit 1210. That is, a coding unit may be recursively split based on at least one of the block shape information and the split shape information of each coding unit. Therefore, a square coding unit may be determined by splitting a non-square coding unit, and a non-square coding unit may be determined by recursively splitting the square coding unit. Referring to FIG. 12, a predetermined coding unit from among an odd number of third coding units 1220b, 1220c, and 1220d determined by splitting the non-square second coding unit 1210 (e.g., a coding unit at a center location or a square coding unit) may be recursively split. According to an embodiment, the square third coding unit 1220c from among the odd number of third coding units 1220b, 1220c, and 1220d may be split in a horizontal direction into a plurality of fourth coding units. A non-square fourth coding unit 1240 from among the plurality of fourth coding units may be split into a plurality of coding units. For example, the non-square fourth coding unit 1240 may be split into an odd number of coding units.

A method that may be used to recursively split a coding unit will be described below in relation to various embodiments.

According to an embodiment, the image decoding device 100 may determine to split each of the third coding units 1220a, or 1220b, 1220c, and 1220d into coding units or not to split the second coding unit 1210, based on at least one of the block shape information and the split shape information. According to an embodiment, the image decoding device 100 may split the non-square second coding unit 1210 into the odd number of third coding units 1220b, 1220c, and 1220d. The image decoding device 100 may put a predetermined restriction on a predetermined third coding unit from among the odd number of third coding units 1220b, 1220c, and 1220d. For example, the image decoding device 100 may restrict the third coding unit 1220c at a center location from among the odd number of third coding units 1220b, 1220c, and 1220d to be no longer split or to be split a settable number of times. Referring to FIG. 12, the image decoding device 100 may restrict the third coding unit 1220c, which is at the center location from among the odd number of third coding units 1220b, 1220c, and 1220d included in the non-square second coding unit 1210, to be no longer split, to be split by using a predetermined splitting method (e.g., split into only four coding units or split by using a splitting method of the second coding unit 1210), or to be split only a predetermined number of times (e.g., split only n times (where n>0)). However, the restrictions on the third coding unit 1220c at the center location are not limited to the above-described examples, and may include various restrictions for decoding the third coding unit 1220c at the center location differently from the other third coding units 1220b and 1220d.

According to an embodiment, the image decoding device 100 may obtain at least one of the block shape information and the split shape information, which is used to split a current coding unit, from a predetermined location in the current coding unit.

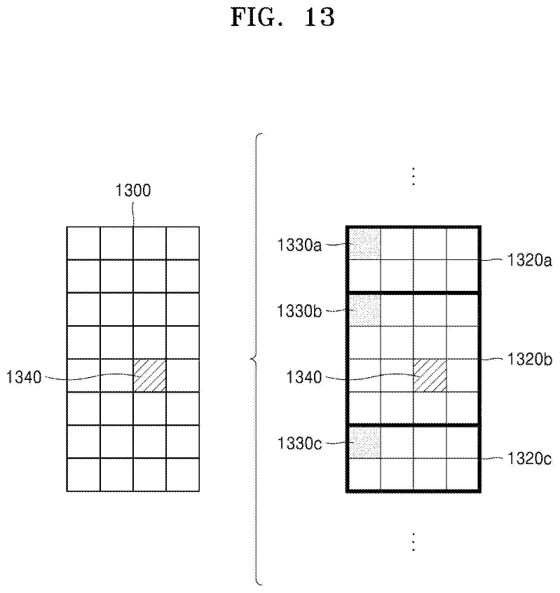

FIG. 13 illustrates a method, performed by the image decoding device 100, of determining a predetermined coding unit from among an odd number of coding units, according to an embodiment. Referring to FIG. 13, at least one of block shape information and split shape information of a current coding unit 1300 may be obtained from a sample of a predetermined location from among a plurality of samples included in the current coding unit 1300 (e.g., a sample 1340 of a center location). However, the predetermined location in the current coding unit 1300, from which at least one of the block shape information and the split shape information may be obtained, is not limited to the center location in FIG. 13, and may include various locations included in the current coding unit 1300 (e.g., top, bottom, left, right, top left, bottom left, top right, and bottom right locations). The image decoding device 100 may obtain at least one of the block shape information and the split shape information from the predetermined location and determine to split or not to split the current coding unit into various-shaped and various-sized coding units.

According to an embodiment, when the current coding unit is split into a predetermined number of coding units, the image decoding device 100 may select one of the coding units. Various methods may be used to select one of a plurality of coding units, as will be described below in relation to various embodiments.

According to an embodiment, the image decoding device 100 may split the current coding unit into a plurality of coding units, and may determine a coding unit at a predetermined location.

FIG. 13 illustrates a method, performed by the image decoding device 100, of determining a coding unit of a predetermined location from among an odd number of coding units, according to an embodiment.

According to an embodiment, the image decoding device 100 may use information indicating locations of the odd number of coding units, to determine a coding unit at a center location from among the odd number of coding units. Referring to FIG. 13, the image decoding device 100 may determine an odd number of coding units 1320a, 1320b, and 1320c by splitting the current coding unit 1300. The image decoding device 100 may determine a coding unit 1320b at a center location by using information about locations of the odd number of coding units 1320a to 1320c. For example, the image decoding device 100 may determine the coding unit 1320b of the center location by determining the locations of the coding units 1320a, 1320b, and 1320c based on information indicating locations of predetermined samples included in the coding units 1320a, 1320b, and 1320c. In detail, the image decoding device 100 may determine the coding unit 1320b at the center location by determining the locations of the coding units 1320a, 1320b, and 1320c based on information indicating locations of top left samples 1330a, 1330b, and 1330c of the coding units 1320a, 1320b, and 1320c.

According to an embodiment, the information indicating the locations of the top left samples 1330a, 1330b, and 1330c, which are included in the coding units 1320a, 1320b, and 1320c, respectively, may include information about locations or coordinates of the coding units 1320a, 1320b, and 1320c in a picture. According to an embodiment, the information indicating the locations of the top left samples 1330a, 1330b, and 1330c, which are included in the coding units 1320a, 1320b, and 1320c, respectively, may include information indicating widths or heights of the coding units 1320a, 1320b, and 1320c included in the current coding unit 1300, and the widths or heights may correspond to information indicating differences between the coordinates of the coding units 1320a, 1320b, and 1320c in the picture. That is, the image decoding device 100 may determine the coding unit 1320b at the center location by directly using the information about the locations or coordinates of the coding units 1320a, 1320b, and 1320c in the picture, or by using the information about the widths or heights of the coding units, which correspond to the difference values between the coordinates.

According to an embodiment, information indicating the location of the top left sample 1330a of the upper coding unit 1320c may include coordinates (xa, ya), information indicating the location of the top left sample 1330b of the middle coding unit 1320b may include coordinates (xb, yb), and information indicating the location of the top left sample 1330c of the lower coding unit 1320c may include coordinates (xc, yc). The image decoding device 100 may determine the middle coding unit 1320b by using the coordinates of the top left samples 1330a, 1330b, and 1330c which are included in the coding units 1320a, 1320b, and 1320c, respectively. For example, when the coordinates of the top left samples 1330a, 1330b, and 1330c are sorted in an ascending or descending order, the coding unit 1320b including the coordinates (xb, yb) of the sample 1330b at a center location may be determined as a coding unit at a center location from among the coding units 1320a, 1320b, and 1320c determined by splitting the current coding unit 1300. However, the coordinates indicating the locations of the top left samples 1330a, 1330b, and 1330c may include coordinates indicating absolute locations in the picture, or may use coordinates (dxb, dyb) indicating a relative location of the top left sample 1330b of the middle coding unit 1320b and coordinates (dxc, dyc) indicating a relative location of the top left sample 1330c of the lower coding unit 1320c with reference to the location of the top left sample 1330a of the upper coding unit 1320a. A method of determining a coding unit at a predetermined location by using coordinates of a sample included in the coding unit, as information indicating a location of the sample, is not limited to the above-described method, and may include various arithmetic methods capable of using the coordinates of the sample.

According to an embodiment, the image decoding device 100 may split the current coding unit 1300 into a plurality of coding units 1320a, 1320b, and 1320c, and may select one of the coding units 1320a, 1320b, and 1320c based on a predetermined criterion. For example, the image decoding device 100 may select the coding unit 1320b, which has a size different from that of the others, from among the coding units 1320a, 1320b, and 1320c.

According to an embodiment, the image decoding device 100 may determine the widths or heights of the coding units 1320a, 1320b, and 1320c by using the coordinates (xa, ya) indicating the location of the top left sample 1330a of the upper coding unit 1320a, the coordinates (xb, yb) indicating the location of the top left sample 1330b of the middle coding unit 1320b, and the coordinates (xc, yc) indicating the location of the top left sample 1330c of the lower coding unit 1320c. The image decoding device 100 may determine the respective sizes of the coding units 1320a, 1320b, and 1320c by using the coordinates (xa, ya), (xb, yb), and (xc, yc) indicating the locations of the coding units 1320a, 1320b, and 1320c.

According to an embodiment, the image decoding device 100 may determine the width of the upper coding unit 1320c to be xb-xa and determine the height thereof to be yb-ya. According to an embodiment, the image decoding device 100 may determine the width of the middle coding unit 1320b to be xc-xb and determine the height thereof to be yc-yb. According to an embodiment, the image decoding device 100 may determine the width or height of the lower coding unit 1320c by using the width or height of the current coding unit 1300 or the widths or heights of the upper and middle coding units 1320c and 1320b. The image decoding device 100 may determine a coding unit, which has a size different from that of the others, based on the determined widths and heights of the coding units 1320c to 1320c. Referring to FIG. 13, the image decoding device 100 may determine the middle coding unit 1320b, which has a size different from the size of the upper and lower coding units 1320c and 1320c, as the coding unit of the predetermined location. However, the above-described method, performed by the image decoding device 100, of determining a coding unit having a size different from the size of the other coding units merely corresponds to an example of determining a coding unit at a predetermined location by using the sizes of coding units, which are determined based on coordinates of samples, and thus various methods of determining a coding unit at a predetermined location by comparing the sizes of coding units, which are determined based on coordinates of predetermined samples, may be used.

However, locations of samples considered to determine locations of coding units are not limited to the above-described top left locations, and information about arbitrary locations of samples included in the coding units may be used.

According to an embodiment, the image decoding device 100 may select a coding unit at a predetermined location from among an odd number of coding units determined by splitting the current coding unit, considering the shape of the current coding unit. For example, when the current coding unit has a non-square shape, a width of which is longer than a height, the image decoding device 100 may determine the coding unit at the predetermined location in a horizontal direction. That is, the image decoding device 100 may determine one of coding units at different locations in a horizontal direction and put a restriction on the coding unit. When the current coding unit has a non-square shape, a height of which is longer than a width, the image decoding device 100 may determine the coding unit at the predetermined location in a vertical direction. That is, the image decoding device 100 may determine one of coding units at different locations in a vertical direction and may put a restriction on the coding unit.

According to an embodiment, the image decoding device 100 may use information indicating respective locations of an even number of coding units, to determine the coding unit at the predetermined location from among the even number of coding units. The image decoding device 100 may determine an even number of coding units by splitting the current coding unit, and may determine the coding unit at the predetermined location by using the information about the locations of the even number of coding units. An operation related thereto may correspond to the operation of determining a coding unit at a predetermined location (e.g., a center location) from among an odd number of coding units, which has been described in detail above in relation to FIG. 13, and thus detailed descriptions thereof are not provided here.

According to an embodiment, when a non-square current coding unit is split into a plurality of coding units, predetermined information about a coding unit at a predetermined location may be used in a splitting operation to determine the coding unit at the predetermined location from among the plurality of coding units. For example, the image decoding device 100 may use at least one of block shape information and split shape information, which is stored in a sample included in a coding unit at a center location, in a splitting operation to determine the coding unit at the center location from among the plurality of coding units determined by splitting the current coding unit.

Referring to FIG. 13, the image decoding device 100 may split the current coding unit 1300 into a plurality of coding units 1320a, 1320b, and 1320c based on at least one of the block shape information and the split shape information, and may determine a coding unit 1320b at a center location from among the plurality of the coding units 1320a, 1320b, and 1320c. Furthermore, the image decoding device 100 may determine the coding unit 1320b at the center location, in consideration of a location from which at least one of the block shape information and the split shape information is obtained. That is, at least one of the block shape information and the split shape information of the current coding unit 1300 may be obtained from the sample 1340 at a center location of the current coding unit 1300 and, when the current coding unit 1300 is split into the plurality of coding units 1320a, 1320b, and 1320c based on at least one of the block shape information and the split shape information, the coding unit 1320b including the sample 1340 may be determined as the coding unit at the center location. However, information used to determine the coding unit at the center location is not limited to at least one of the block shape information and the split shape information, and various types of information may be used to determine the coding unit at the center location.

According to an embodiment, predetermined information for identifying the coding unit at the predetermined location may be obtained from a predetermined sample included in a coding unit to be determined. Referring to FIG. 13, the image decoding device 100 may use at least one of the block shape information and the split shape information, which is obtained from a sample at a predetermined location in the current coding unit 1300 (e.g., a sample at a center location of the current coding unit 1300) to determine a coding unit at a predetermined location from among the plurality of the coding units 1320a, 1320b, and 1320c determined by splitting the current coding unit 1300 (e.g., a coding unit at a center location from among a plurality of split coding units). That is, the image decoding device 100 may determine the sample at the predetermined location by considering a block shape of the current coding unit 1300, determine the coding unit 1320b including a sample, from which predetermined information (e.g., at least one of the block shape information and the split shape information) may be obtained, from among the plurality of coding units 1320a, 1320b, and 1320c determined by splitting the current coding unit 1300, and may put a predetermined restriction on the coding unit 1320b. Referring to FIG. 13, according to an embodiment, the image decoding device 100 may determine the sample 1340 at the center location of the current coding unit 1300 as the sample from which the predetermined information may be obtained, and may put a predetermined restriction on the coding unit 1320b including the sample 1340, in a decoding operation. However, the location of the sample from which the predetermined information may be obtained is not limited to the above-described location, and may include arbitrary locations of samples included in the coding unit 1320b to be determined for a restriction.

According to an embodiment, the location of the sample from which the predetermined information may be obtained may be determined based on the shape of the current coding unit 1300. According to an embodiment, the block shape information may indicate whether the current coding unit has a square or non-square shape, and the location of the sample from which the predetermined information may be obtained may be determined based on the shape. For example, the image decoding device 100 may determine a sample located on a boundary for dividing at least one of a width and height of the current coding unit in half, as the sample from which the predetermined information may be obtained, by using at least one of information about the width of the current coding unit and information about the height of the current coding unit. As another example, when the block shape information of the current coding unit indicates a non-square shape, the image decoding device 100 may determine one of samples adjacent to a boundary for dividing a long side of the current coding unit in half, as the sample from which the predetermined information may be obtained.

According to an embodiment, when the current coding unit is split into a plurality of coding units, the image decoding device 100 may use at least one of the block shape information and the split shape information to determine a coding unit at a predetermined location from among the plurality of coding units. According to an embodiment, the image decoding device 100 may obtain at least one of the block shape information and the split shape information from a sample at a predetermined location in a coding unit, and split the plurality of coding units, which are generated by splitting the current coding unit, by using at least one of the split shape information and the block shape information, which is obtained from the sample of the predetermined location in each of the plurality of coding units. That is, a coding unit may be recursively split based on at least one of the block shape information and the split shape information, which is obtained from the sample at the predetermined location in each coding unit. An operation of recursively splitting a coding unit has been described above in relation to FIG. 12, and thus detailed descriptions thereof will not be provided here.

According to an embodiment, the image decoding device 100 may determine one or more coding units by splitting the current coding unit, and may determine an order of decoding the one or more coding units, based on a predetermined block (e.g., the current coding unit).

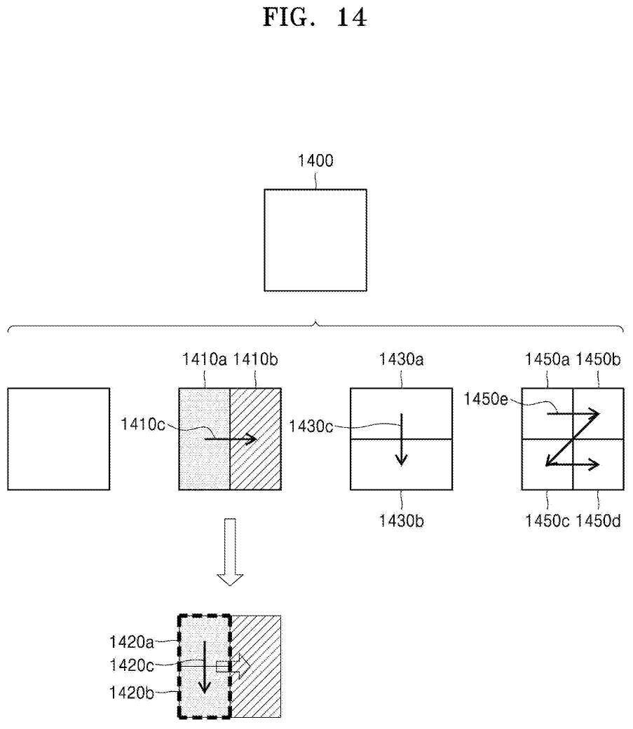

FIG. 14 illustrates an order of processing a plurality of coding units when the image decoding device 100 determines the plurality of coding units by splitting a current coding unit, according to an embodiment.

According to an embodiment, the image decoding device 100 may determine second coding units 1410a and 1410b by splitting a first coding unit 1400 in a vertical direction, determine second coding units 1430a and 1430b by splitting the first coding unit 1400 in a horizontal direction, or determine second coding units 1450a to 1450d by splitting the first coding unit 1400 in vertical and horizontal directions, based on block shape information and split shape information.

Referring to FIG. 14, the image decoding device 100 may determine to process the second coding units 1410a and 1410b, which are determined by splitting the first coding unit 1400 in a vertical direction, in a horizontal direction order 1410c. The image decoding device 100 may determine to process the second coding units 1430a and 1430b, which are determined by splitting the first coding unit 1400 in a horizontal direction, in a vertical direction order 1430c. The image decoding device 100 may determine to process the second coding units 1450a to 1450d, which are determined by splitting the first coding unit 1400 in vertical and horizontal directions, in a predetermined order for processing coding units in a row and then processing coding units in a next row (e.g., in a raster scan order or Z-scan order 1450e).

According to an embodiment, the image decoding device 100 may recursively split coding units. Referring to FIG. 14, the image decoding device 100 may determine a plurality of coding units 1410a, 1410b, 1430a, 1430b, 1450a, 1450b, 1450c, and 1450d by splitting the first coding unit 1400, and may recursively split each of the determined plurality of coding units 1410a, 1410b, 1430a, 1430b, 1450a, 1450b, 1450c, and 1450d. A splitting method of the plurality of coding units 1410a, 1410b, 1430a, 1430b, 1450a, 1450b, 1450c, and 1450d may correspond to a splitting method of the first coding unit 1400. As such, each of the plurality of coding units 1410a, 1410b, 1430a, 1430b, 1450a, 1450b, 1450c, and 1450d may be independently split into a plurality of coding units. Referring to FIG. 14, the image decoding device 100 may determine the second coding units 1410a and 1410b by splitting the first coding unit 1400 in a vertical direction, and may determine to independently split or not to split each of the second coding units 1410a and 1410b.

According to an embodiment, the image decoding device 100 may determine third coding units 1420a and 1420b by splitting the left second coding unit 1410a in a horizontal direction, and may not split the right second coding unit 1410b.

According to an embodiment, a processing order of coding units may be determined based on an operation of splitting a coding unit. In other words, a processing order of split coding units may be determined based on a processing order of coding units immediately before being split. The image decoding device 100 may determine a processing order of the third coding units 1420a and 1420b determined by splitting the left second coding unit 1410a, independently of the right second coding unit 1410b. Because the third coding units 1420a and 1420b are determined by splitting the left second coding unit 1410a in a horizontal direction, the third coding units 1420a and 1420b may be processed in a vertical direction order 1420c. Because the left and right second coding units 1410a and 1410b are processed in the horizontal direction order 1410c, the right second coding unit 1410b may be processed after the third coding units 1420a and 1420b included in the left second coding unit 1410a are processed in the vertical direction order 1420c. An operation of determining a processing order of coding units based on a coding unit before being split is not limited to the above-described example, and various methods may be used to independently process coding units, which are split and determined to various shapes, in a predetermined order.

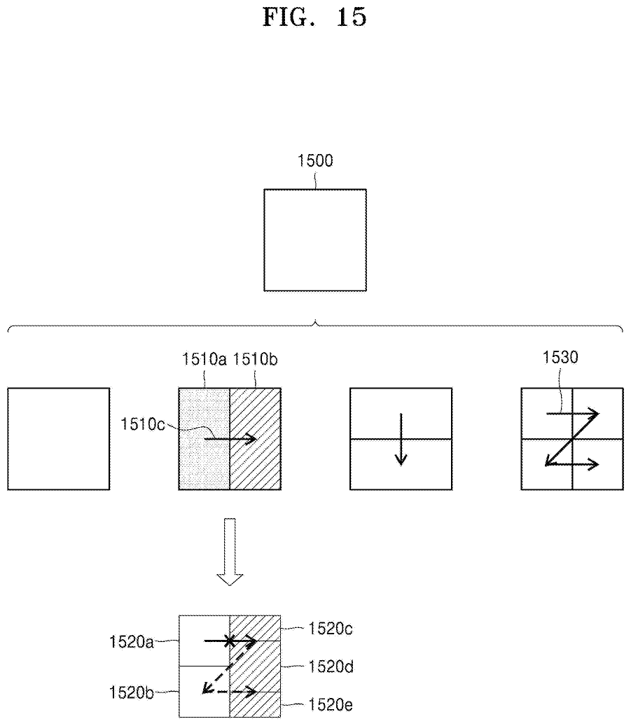

FIG. 15 illustrates a process, performed by the image decoding device 100, of determining that a current coding unit is to be split into an odd number of coding units, when the coding units are not processable in a predetermined order, according to an embodiment.

According to an embodiment, the image decoding device 100 may determine whether the current coding unit is split into an odd number of coding units, based on obtained block shape information and split shape information. Referring to FIG. 15, a square first coding unit 1500 may be split into non-square second coding units 1510a and 1510b, and the second coding units 1510a and 1510b may be independently split into third coding units 1520a and 1520b, and 1520c to 1520e. According to an embodiment, the image decoding device 100 may determine a plurality of third coding units 1520a and 1520b by splitting the left second coding unit 1510a in a horizontal direction, and may split the right second coding unit 1510b into an odd number of third coding units 1520c to 1520e.

According to an embodiment, the image decoding device 100 may determine whether any coding unit is split into an odd number of coding units, by determining whether the third coding units 1520a and 1520b, and 1520c to 1520e are processable in a predetermined order. Referring to FIG. 15, the image decoding device 100 may determine the third coding units 1520a and 1520b, and 1520c to 1520e by recursively splitting the first coding unit 1500. The image decoding device 100 may determine whether any of the first coding unit 1500, the second coding units 1510a and 1510b, and the third coding units 1520a and 1520b, and 1520c, 1520d, and 1520e are split into an odd number of coding units, based on at least one of the block shape information and the split shape information. For example, the right second coding unit 1510b may be split into an odd number of third coding units 1520c, 1520d, and 1520e. A processing order of a plurality of coding units included in the first coding unit 1500 may be a predetermined order (e.g., a Z-scan order 1530), and the image decoding device 100 may decide whether the third coding units 1520c, 1520d, and 1520e, which are determined by splitting the right second coding unit 1510b into an odd number of coding units, satisfy a condition for processing in the predetermined order.

According to an embodiment, the image decoding device 100 may determine whether the third coding units 1520a and 1520b, and 1520c, 1520d, and 1520e included in the first coding unit 1500 satisfy the condition for processing in the predetermined order, and the condition relates to whether at least one of a width and height of the second coding units 1510a and 1510b is divided in half along a boundary of the third coding units 1520a and 1520b, and 1520c, 1520d, and 1520e. For example, the third coding units 1520a and 1520b determined by dividing the height of the non-square left second coding unit 1510a in half satisfy the condition. However, because boundaries of the third coding units 1520c, 1520d, and 1520e determined by splitting the right second coding unit 1510b into three coding units do not divide the width or height of the right second coding unit 1510b in half, it may be determined that the third coding units 1520c, 1520d, and 1520e do not satisfy the condition. When the condition is not satisfied as described above, the image decoding device 100 may decide disconnection of a scan order, and determine that the right second coding unit 1510b is split into an odd number of coding units, based on a result of the decision. According to an embodiment, when a coding unit is split into an odd number of coding units, the image decoding device 100 may put a predetermined restriction on a coding unit at a predetermined location among the split coding units. The restriction or the predetermined location has been described above in relation to various embodiments, and thus detailed descriptions thereof will not be provided here.

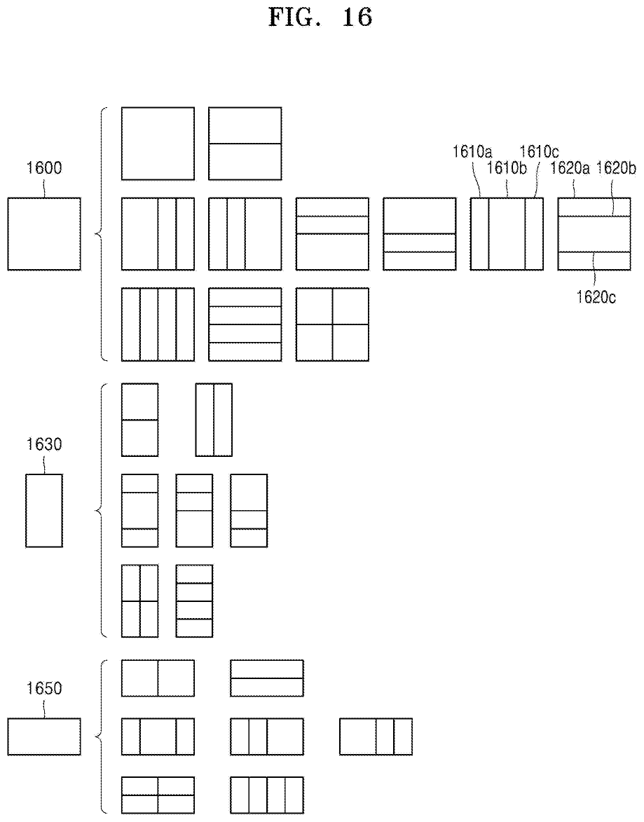

FIG. 16 illustrates a process, performed by the image decoding device 100, of determining at least one coding unit by splitting a first coding unit 1600, according to an embodiment. According to an embodiment, the image decoding device 100 may split the first coding unit 1600, based on at least one of block shape information and split shape information, which is obtained by a receiver 210. The square first coding unit 1600 may be split into four square coding units, or may be split into a plurality of non-square coding units. For example, referring to FIG. 16, when the block shape information indicates that the first coding unit 1600 has a square shape and the split shape information indicates to split the first coding unit 1600 into non-square coding units, the image decoding device 100 may split the first coding unit 1600 into a plurality of non-square coding units. In detail, when the split shape information indicates to determine an odd number of coding units by splitting the first coding unit 1600 in a horizontal direction or a vertical direction, the image decoding device 100 may split the square first coding unit 1600 into an odd number of coding units, e.g., second coding units 1610a, 1610b, and 1610c determined by splitting the square first coding unit 1600 in a vertical direction or second coding units 1620a, 1620b, and 1620c determined by splitting the square first coding unit 1600 in a horizontal direction.

According to an embodiment, the image decoding device 100 may determine whether the second coding units 1610a, 1610b, 1610c, 1620a, 1620b, and 1620c included in the first coding unit 1600 satisfy a condition for processing in a predetermined order, and the condition relates to whether at least one of a width and height of the first coding unit 1600 is divided in half along a boundary of the second coding units 1610a, 1610b, 1610c, 1620a, 1620b, and 1620c. Referring to FIG. 16, because boundaries of the second coding units 1610a, 1610b, and 1610c determined by splitting the square first coding unit 1600 in a vertical direction do not divide the width of the first coding unit 1600 in half, it may be determined that the first coding unit 1600 does not satisfy the condition for processing in the predetermined order. In addition, because boundaries of the second coding units 1620a, 1620b, and 1620c determined by splitting the square first coding unit 1600 in a horizontal direction do not divide the width of the first coding unit 1600 in half, it may be determined that the first coding unit 1600 does not satisfy the condition for processing in the predetermined order. When the condition is not satisfied as described above, the image decoding device 100 may decide disconnection of a scan order, and may determine that the first coding unit 1600 is split into an odd number of coding units, based on a result of the decision. According to an embodiment, when a coding unit is split into an odd number of coding units, the image decoding device 100 may put a predetermined restriction on a coding unit at a predetermined location from among the split coding units. The restriction or the predetermined location has been described above in relation to various embodiments, and thus detailed descriptions thereof will not be provided herein.

According to an embodiment, the image decoding device 100 may determine various-shaped coding units by splitting a first coding unit.

Referring to FIG. 16, the image decoding device 100 may split the square first coding unit 1600 or a non-square first coding unit 1630 or 1650 into various-shaped coding units.

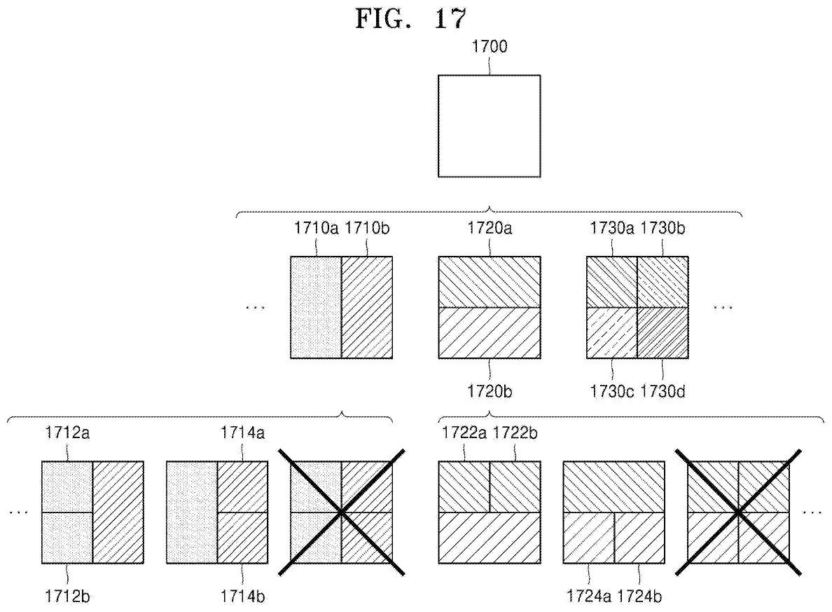

FIG. 17 illustrates that a shape into which a second coding unit is splittable by the image decoding device 100 is restricted when the second coding unit having a non-square shape, which is determined by splitting a first coding unit 1700, satisfies a predetermined condition, according to an embodiment.

According to an embodiment, the image decoding device 100 may determine to split the square first coding unit 1700 into non-square second coding units 1710a, 1710b, 1720a, and 1720b, based on at least one of block shape information and split shape information, which is obtained by the receiver 210. The second coding units 1710a, 1710b, 1720a, and 1720b may be independently split. As such, the image decoding device 100 may determine to split or not to split the first coding unit 1700 into a plurality of coding units, based on at least one of the block shape information and the split shape information of each of the second coding units 1710a, 1710b, 1720a, and 1720b. According to an embodiment, the image decoding device 100 may determine third coding units 1712a and 1712b by splitting the non-square left second coding unit 1710a, which is determined by splitting the first coding unit 1700 in a vertical direction, in a horizontal direction. However, when the left second coding unit 1710a is split in a horizontal direction, the image decoding device 100 may restrict the right second coding unit 1710b to not be split in a horizontal direction in which the left second coding unit 1710a is split. When third coding units 1714a and 1714b are determined by splitting the right second coding unit 1710b in a same direction, because the left and right second coding units 1710a and 1710b are independently split in a horizontal direction, the third coding units 1712a, 1712b, 1714a, and 1714b may be determined. However, this case serves equally as a case in which the image decoding device 100 splits the first coding unit 1700 into four square second coding units 1730a, 1730b, 1730c, and 1730d, based on at least one of the block shape information and the split shape information, and may be inefficient in terms of image decoding.

According to an embodiment, the image decoding device 100 may determine third coding units 1722a, 1722b, 1724a, and 1724b by splitting the non-square second coding unit 1720a or 1720b, which is determined by splitting a first coding unit 1700 in a horizontal direction, in a vertical direction. However, when a second coding unit (e.g., the upper second coding unit 1720a) is split in a vertical direction, for the above-described reason, the image decoding device 100 may restrict the other second coding unit (e.g., the lower second coding unit 1720b) to not be split in a vertical direction in which the upper second coding unit 1720a is split.

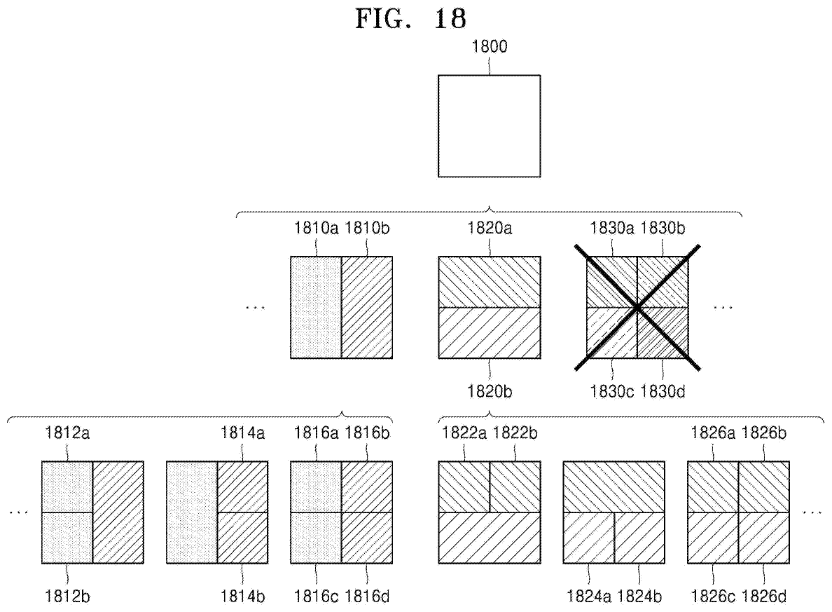

FIG. 18 illustrates a process, performed by the image decoding device 100, of splitting a square coding unit when split shape information indicates that the square coding unit is not to be split into four square coding units, according to an embodiment.

According to an embodiment, the image decoding device 100 may determine second coding units 1810a, 1810b, 1820a, 1820b, etc. by splitting a first coding unit 1800, based on at least one of block shape information and split shape information. The split shape information may include information about various methods of splitting a coding unit but, the information about various splitting methods may not include information for splitting a coding unit into four square coding units. According to such split shape information, the image decoding device 100 may not split the first square coding unit 1800 into four square second coding units 1830a, 1830b, 1830c, and 1830d. The image decoding device 100 may determine the non-square second coding units 1810a, 1810b, 1820a, 1820b, etc., based on the split shape information.

According to an embodiment, the image decoding device 100 may independently split the non-square second coding units 1810a, 1810b, 1820a, 1820b, etc. Each of the second coding units 1810a, 1810b, 1820a, 1820b, etc. may be recursively split in a predetermined order, and this splitting method may correspond to a method of splitting the first coding unit 1800, based on at least one of the block shape information and the split shape information.

For example, the image decoding device 100 may determine square third coding units 1812a and 1812b by splitting the left second coding unit 1810a in a horizontal direction, and may determine square third coding units 1814a and 1814b by splitting the right second coding unit 1810b in a horizontal direction. Furthermore, the image decoding device 100 may determine square third coding units 1816a, 1816b, 1816c, and 1816d by splitting both of the left and right second coding units 1810a and 1810b in a horizontal direction. In this case, coding units having the same shape as the four square second coding units 1830a, 1830b, 1830c, and 1830d split from the first coding unit 1800 may be determined.

As another example, the image decoding device 100 may determine square third coding units 1822a and 1822b by splitting the upper second coding unit 1820a in a vertical direction, and may determine square third coding units 1824a and 1824b by splitting the lower second coding unit 1820b in a vertical direction. Furthermore, the image decoding device 100 may determine square third coding units 1822a, 1822b, 1824a, and 1824b by splitting both of the upper and lower second coding units 1820a and 1820b in a vertical direction. In this case, coding units having the same shape as the four square second coding units 1830a, 1830b, 1830c, and 1830d split from the first coding unit 1800 may be determined.

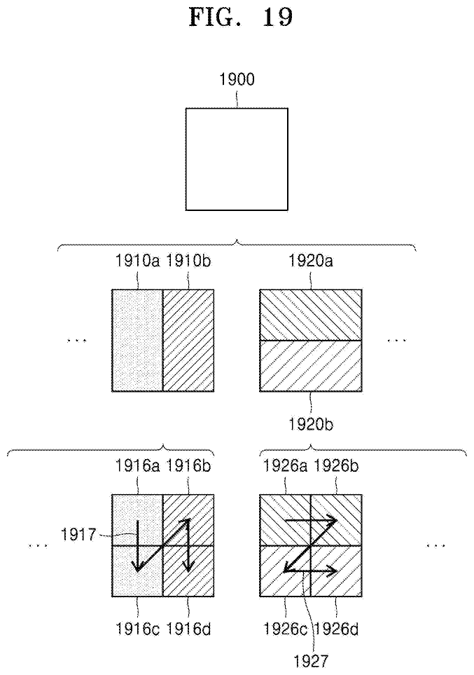

FIG. 19 illustrates that a processing order between a plurality of coding units may be changed depending on a process of splitting a coding unit, according to an embodiment.

According to an embodiment, the image decoding device 100 may split a first coding unit 1900, based on block shape information and split shape information. When the block shape information indicates a square shape and the split shape information indicates to split the first coding unit 1900 in at least one of horizontal and vertical directions, the image decoding device 100 may determine second coding units 1910a, 1910b, 1920a, 1920b, 1930a, 1930b, 1930c, and 1930d by splitting the first coding unit 1900. Referring to FIG. 19, the non-square second coding units 1910a, 1910b, 1920a, and 1920b determined by splitting the first coding unit 1900 in only a horizontal direction or vertical direction may be independently split based on the block shape information and the split shape information of each coding unit. For example, the image decoding device 100 may determine third coding units 1916a, 1916b, 1916c, and 1916d by splitting the second coding units 1910a and 1910b, which are generated by splitting the first coding unit 1900 in a vertical direction, in a horizontal direction, and may determine third coding units 1926a, 1926b, 1926c, and 1926d by splitting the second coding units 1920a and 1920b, which are generated by splitting the first coding unit 1900 in a horizontal direction, in a vertical direction. An operation of splitting the second coding units 1910a, 1910b, 1920a, and 1920b has been described above in relation to FIG. 17, and thus detailed descriptions thereof will not be provided herein.

According to an embodiment, the image decoding device 100 may process coding units in a predetermined order. An operation of processing coding units in a predetermined order has been described above in relation to FIG. 14, and thus detailed descriptions thereof will not be provided herein. Referring to FIG. 19, the image decoding device 100 may determine four square third coding units 1916a, 1916b, 1916c, and 1916d, and 1926a, 1926b, 1926c, and 1926d by splitting the square first coding unit 1900. According to an embodiment, the image decoding device 100 may determine processing orders of the third coding units 1916a, 1916b, 1916c, and 1916d, and 1926a, 1926b, 1926c, and 1926d based on a splitting method of the first coding unit 1900.

According to an embodiment, the image decoding device 100 may determine the third coding units 1916a, 1916b, 1916c, and 1916d by splitting the second coding units 1910a and 1910b generated by splitting the first coding unit 1900 in a vertical direction, in a horizontal direction, and may process the third coding units 1916a, 1916b, 1916c, and 1916d in a processing order 1917 for initially processing the third coding units 1916a and 1916c, which are included in the left second coding unit 1910a, in a vertical direction and then processing the third coding unit 1916b and 1916d, which are included in the right second coding unit 1910b, in a vertical direction.

According to an embodiment, the image decoding device 100 may determine the third coding units 1926a, 1926b, 1926c, and 1926d by splitting the second coding units 1920a and 1920b generated by splitting the first coding unit 1900 in a horizontal direction, in a vertical direction, and may process the third coding units 1926a, 1926b, 1926c, and 1926d in a processing order 1927 for initially processing the third coding units 1926a and 1926b, which are included in the upper second coding unit 1920a, in a horizontal direction and then processing the third coding unit 1926c and 1926d, which are included in the lower second coding unit 1920b, in a horizontal direction.

Referring to FIG. 19, the square third coding units 1916a, 1916b, 1916c, and 1916d, and 1926a, 1926b, 1926c, and 1926d may be determined by splitting the second coding units 1910a, 1910b, 1920a, and 1920b, respectively. Although the second coding units 1910a and 1910b are determined by splitting the first coding unit 1900 in a vertical direction differently from the second coding units 1920a and 1920b which are determined by splitting the first coding unit 1900 in a horizontal direction, the third coding units 1916a, 1916b, 1916c, and 1916d, and 1926a, 1926b, 1926c, and 1926d split therefrom eventually show same-shaped coding units split from the first coding unit 1900. As such, by recursively splitting a coding unit in different manners based on at least one of the block shape information and the split shape information, the image decoding device 100 may process a plurality of coding units in different orders even when the coding units are eventually determined to be the same shape.

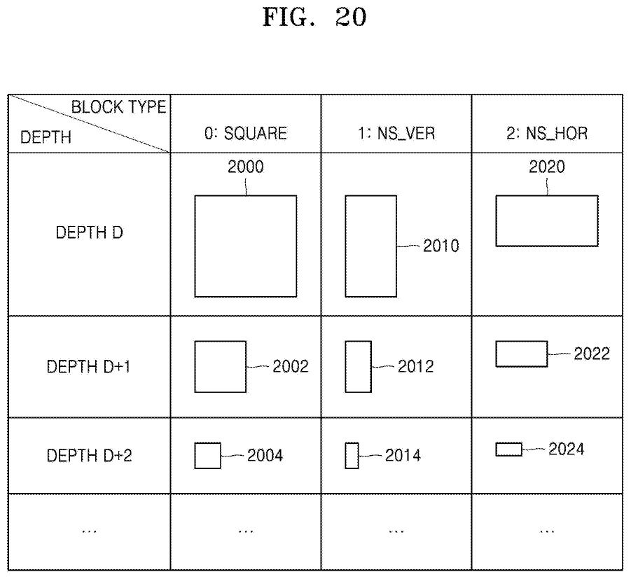

FIG. 20 illustrates a process of determining a depth of a coding unit as a shape and size of the coding unit change, when the coding unit is recursively split such that a plurality of coding units are determined, according to an embodiment.

According to an embodiment, the image decoding device 100 may determine the depth of the coding unit, based on a predetermined criterion. For example, the predetermined criterion may be the length of a long side of the coding unit. When the length of a long side of a coding unit before being split is 2n times (n>0) the length of a long side of a split current coding unit, the image decoding device 100 may determine that a depth of the current coding unit is increased from a depth of the coding unit before being split, by n. In the following description, a coding unit having an increased depth is expressed as a coding unit of a deeper depth.

Referring to FIG. 20, according to an embodiment, the image decoding device 100 may determine a second coding unit 2002 and a third coding unit 2004 of deeper depths by splitting a square first coding unit 2000 based on block shape information indicating a square shape (for example, the block shape information may be expressed as ‘0: SQUARE’). Assuming that the size of the square first coding unit 2000 is 2N×2N, the second coding unit 2002 determined by dividing a width and height of the first coding unit 2000 to ½¹ may have a size of N×N. Furthermore, the third coding unit 2004 determined by dividing a width and height of the second coding unit 2002 to ½ may have a size of N/2×N/2. In this case, a width and height of the third coding unit 2004 are ½² times those of the first coding unit 2000. When a depth of the first coding unit 2000 is D, a depth of the second coding unit 2002, the width and height of which are ½¹ times those of the first coding unit 2000, may be D+1, and a depth of the third coding unit 2004, the width and height of which are ½² times those of the first coding unit 2000, may be D+2.

According to an embodiment, the image decoding device 100 may determine a second coding unit 2012 or 2022 and a third coding unit 2014 or 2024 of deeper depths by splitting a non-square first coding unit 2010 or 2020 based on block shape information indicating a non-square shape (for example, the block shape information may be expressed as ‘1: NS_VER’ indicating a non-square shape, a height of which is longer than a width, or as ‘2: NS_HOR’ indicating a non-square shape, a width of which is longer than a height).

The image decoding device 100 may determine a second coding unit 2002, 2012, or 2022 by dividing at least one of a width and height of the first coding unit 2010 having a size of N×2N. That is, the image decoding device 100 may determine the second coding unit 2002 having a size of N×N or the second coding unit 2022 having a size of N×N/2 by splitting the first coding unit 2010 in a horizontal direction, or may determine the second coding unit 2012 having a size of N/2×N by splitting the first coding unit 2010 in horizontal and vertical directions.

According to an embodiment, the image decoding device 100 may determine the second coding unit 2002, 2012, or 2022 by dividing at least one of a width and height of the first coding unit 2020 having a size of 2N×N. That is, the image decoding device 100 may determine the second coding unit 2002 having a size of N×N or the second coding unit 2012 having a size of N/2×N by splitting the first coding unit 2020 in a vertical direction, or may determine the second coding unit 2022 having a size of N×N/2 by splitting the first coding unit 2020 in horizontal and vertical directions.

According to an embodiment, the image decoding device 100 may determine a third coding unit 2004, 2014, or 2024 by dividing at least one of a width and height of the second coding unit 2002 having a size of N×N. That is, the image decoding device 100 may determine the third coding unit 2004 having a size of N/2×N/2, the third coding unit 2014 having a size of N/2²×N/2, or the third coding unit 2024 having a size of N/2×N/2² by splitting the second coding unit 2002 in vertical and horizontal directions.

According to an embodiment, the image decoding device 100 may determine the third coding unit 2004, 2014, or 2024 by dividing at least one of a width and height of the second coding unit 2012 having a size of N/2×N. That is, the image decoding device 100 may determine the third coding unit 2004 having a size of N/2×N/2 or the third coding unit 2024 having a size of N/2×N/2² by splitting the second coding unit 2012 in a horizontal direction, or may determine the third coding unit 2014 having a size of N/2²×N/2 by splitting the second coding unit 2012 in vertical and horizontal directions.

According to an embodiment, the image decoding device 100 may determine the third coding unit 2004, 2014, or 2024 by dividing at least one of a width and height of the second coding unit 2022 having a size of N×N/2. That is, the image decoding device 100 may determine the third coding unit 2004 having a size of N/2×N/2 or the third coding unit 2014 having a size of N/2²×N/2 by splitting the second coding unit 2022 in a vertical direction, or may determine the third coding unit 2024 having a size of N/2×N/2² by splitting the second coding unit 2022 in vertical and horizontal directions.

According to an embodiment, the image decoding device 100 may split the square coding unit 2000, 2002, or 2004 in a horizontal or vertical direction. For example, the image decoding device 100 may determine the first coding unit 2010 having a size of N×2N by splitting the first coding unit 2000 having a size of 2N×2N in a vertical direction, or may determine the first coding unit 2020 having a size of 2N×N by splitting the first coding unit 2000 in a horizontal direction. According to an embodiment, when a depth is determined based on the length of the longest side of a coding unit, a depth of a coding unit determined by splitting the first coding unit 2000, 2002 or 2004 having a size of 2N×2N in a horizontal or vertical direction may be the same as the depth of the first coding unit 2000, 2002 or 2004.

According to an embodiment, a width and height of the third coding unit 2014 or 2024 may be ½² times those of the first coding unit 2010 or 2020. When a depth of the first coding unit 2010 or 2020 is D, a depth of the second coding unit 2012 or 2022, the width and height of which are ½ times those of the first coding unit 2010 or 2020, may be D+1, and a depth of the third coding unit 2014 or 2024, the width and height of which are ½² times those of the first coding unit 2010 or 2020, may be D+2.

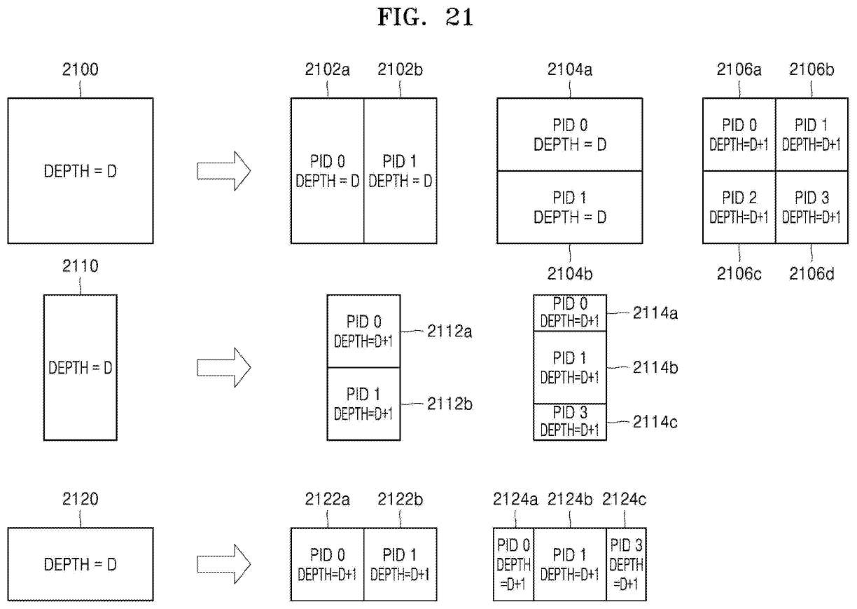

FIG. 21 illustrates depths that are determinable based on shapes and sizes of coding units, and part indexes (PIDs) that are for distinguishing the coding units, according to an embodiment.

According to an embodiment, the image decoding device 100 may determine various-shape second coding units by splitting a square first coding unit 2100. Referring to FIG. 21, the image decoding device 100 may determine second coding units 2102a and 2102b, 2104a and 2104b, and 2106a, 2106b, 2106c, and 2106d by splitting the first coding unit 2100 in at least one of vertical and horizontal directions based on split shape information. That is, the image decoding device 100 may determine the second coding units 2102a and 2102b, 2104a and 2104b, and 2106a, 2106b, 2106c, and 2106d, based on the split shape information of the first coding unit 2100.

According to an embodiment, a depth of the second coding units 2102a and 2102b, 2104a and 2104b, and 2106a, 2106b, 2106c, and 2106d, which are determined based on the split shape information of the square first coding unit 2100, may be determined based on the length of a long side thereof. For example, because the length of a side of the square first coding unit 2100 equals the length of a long side of the non-square second coding units 2102a and 2102b, and 2104a and 2104b, the first coding unit 2100 and the non-square second coding units 2102a and 2102b, and 2104a and 2104b may have the same depth, e.g., D. However, when the image decoding device 100 splits the first coding unit 2100 into the four square second coding units 2106a, 2106b, 2106c, and 2106d based on the split shape information, because the length of a side of the square second coding units 2106a, 2106b, 2106c, and 2106d is ½ times the length of a side of the first coding unit 2100, a depth of the second coding units 2106a, 2106b, 2106c, and 2106d may be D+1 which is deeper than the depth D of the first coding unit 2100 by 1.

According to an embodiment, the image decoding device 100 may determine a plurality of second coding units 2112a and 2112b, and 2114a, 2114b, and 2114c by splitting a first coding unit 2110, a height of which is longer than a width, in a horizontal direction based on the split shape information. According to an embodiment, the image decoding device 100 may determine a plurality of second coding units 2122a and 2122b, and 2124a, 2124b, and 2124c by splitting a first coding unit 2120, a width of which is longer than a height, in a vertical direction based on the split shape information.

According to an embodiment, a depth of the second coding units 2112a and 2112b, 2114a, 2114b, and 2114c, 2122a and 2122b, and 2124a, 2124b, and 2124c, which are determined based on the split shape information of the non-square first coding unit 2110 or 2120, may be determined based on the length of a long side thereof. For example, because the length of a side of the square second coding units 2112a and 2112b is ½ times the length of a long side of the first coding unit 2110 having a non-square shape, a height of which is longer than a width, a depth of the square second coding units 2112a and 2112b is D+1 which is deeper than the depth D of the non-square first coding unit 2110 by 1.

Furthermore, the image decoding device 100 may split the non-square first coding unit 2110 into an odd number of second coding units 2114a, 2114b,and 2114c based on the split shape information. The odd number of second coding units 2114a, 2114b, and 2114c may include the non-square second coding units 2114a and 2114c and the square second coding unit 2114b. In this case, because the length of a long side of the non-square second coding units 2114a and 2114c and the length of a side of the square second coding unit 2114b are ½ times the length of a long side of the first coding unit 2110, a depth of the second coding units 2114a, 2114b, and 2114c may be D+1 which is deeper than the depth D of the non-square first coding unit 2110 by 1. The image decoding device 100 may determine depths of coding units split from the first coding unit 2120 having a non-square shape, a width of which is longer than a height, by using the above-described method of determining depths of coding units split from the first coding unit 2110.

According to an embodiment, the image decoding device 100 may determine PIDs for identifying split coding units, based on a size ratio between the coding units when an odd number of split coding units do not have equal sizes. Referring to FIG. 21, a coding unit 2114b of a center location among an odd number of split coding units 2114a, 2114b, and 2114c may have a width equal to that of the other coding units 2114a and 2114c and a height which is two times that of the other coding units 2114a and 2114c. That is, in this case, the coding unit 2114b at the center location may include two of the other coding unit 2114a or 2114c. Therefore, when a PID of the coding unit 2114b at the center location is 1 based on a scan order, a PID of the coding unit 2114c located next to the coding unit 2114b may be increased by 2 and thus may be 3. That is, discontinuity in PID values may be present. According to an embodiment, the image decoding device 100 may determine whether an odd number of split coding units do not have equal sizes, based on whether discontinuity is present in PIDs for identifying the split coding units.

According to an embodiment, the image decoding device 100 may determine whether to use a specific splitting method, based on PID values for identifying a plurality of coding units determined by splitting a current coding unit. Referring to FIG. 21, the image decoding device 100 may determine an even number of coding units 2112a and 2112b or an odd number of coding units 2114a, 2114b, and 2114c by splitting the first coding unit 2110 having a rectangular shape, a height of which is longer than a width. The image decoding device 100 may use PIDs to identify respective coding units. According to an embodiment, the PID may be obtained from a sample of a predetermined location of each coding unit (e.g., a top left sample).

According to an embodiment, the image decoding device 100 may determine a coding unit at a predetermined location from among the split coding units, by using the PIDs for distinguishing the coding units. According to an embodiment, when the split shape information of the first coding unit 2110 having a rectangular shape, a height of which is longer than a width, indicates to split a coding unit into three coding units, the image decoding device 100 may split the first coding unit 2110 into three coding units 2114a, 2114b, and 2114c. The image decoding device 100 may assign a PID to each of the three coding units 2114a, 2114b, and 2114c. The image decoding device 100 may compare PIDs of an odd number of split coding units to determine a coding unit at a center location from among the coding units. The image decoding device 100 may determine the coding unit 2114b having a PID corresponding to a middle value among the PIDs of the coding units, as the coding unit at the center location from among the coding units determined by splitting the first coding unit 2110. According to an embodiment, the image decoding device 100 may determine PIDs for distinguishing split coding units, based on a size ratio between the coding units when the split coding units do not have equal sizes. Referring to FIG. 21, the coding unit 2114b generated by splitting the first coding unit 2110 may have a width equal to that of the other coding units 2114a and 2114c and a height which is two times that of the other coding units 2114a and 2114c. In this case, when the PID of the coding unit 2114b at the center location is 1, the PID of the coding unit 2114c located next to the coding unit 2114b may be increased by 2 and thus may be 3. When the PID is not uniformly increased as described above, the image decoding device 100 may determine that a coding unit is split into a plurality of coding units including a coding unit having a size different from that of the other coding units. According to an embodiment, when the split shape information indicates to split a coding unit into an odd number of coding units, the image decoding device 100 may split a current coding unit in such a manner that a coding unit of a predetermined location among an odd number of coding units (e.g., a coding unit of a centre location) has a size different from that of the other coding units. In this case, the image decoding device 100 may determine the coding unit of the centre location, which has a different size, by using PIDs of the coding units. However, the PIDs and the size or location of the coding unit of the predetermined location are not limited to the above-described examples, and various PIDs and various locations and sizes of coding units may be used.

According to an embodiment, the image decoding device 100 may use a predetermined data unit where a coding unit starts to be recursively split.

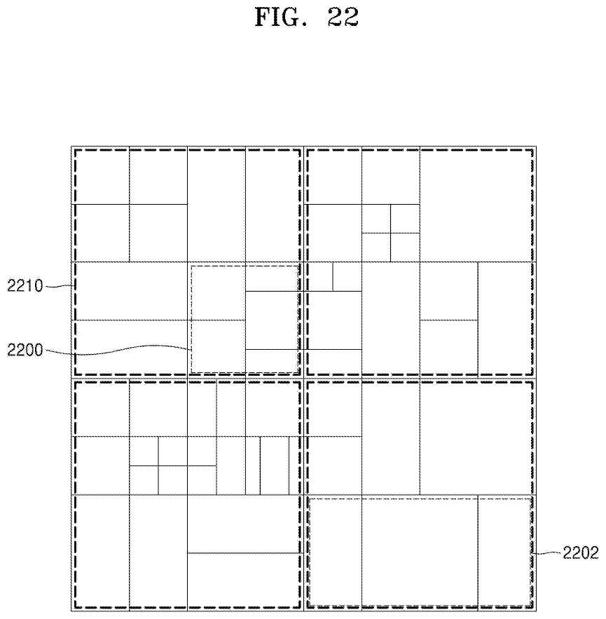

FIG. 22 illustrates that a plurality of coding units are determined based on a plurality of predetermined data units included in a picture, according to an embodiment.

According to an embodiment, a predetermined data unit may be defined as a data unit where a coding unit starts to be recursively split by using at least one of block shape information and split shape information. That is, the predetermined data unit may correspond to a coding unit of an uppermost depth, which is used to determine a plurality of coding units split from a current picture. In the following descriptions, for convenience of explanation, the predetermined data unit is referred to as a reference data unit.

According to an embodiment, the reference data unit may have a predetermined size and a predetermined size shape. According to an embodiment, the reference data unit may include M×N samples. Herein, M and N may be equal to each other, and may be integers expressed as n-th power of 2. That is, the reference data unit may have a square or non-square shape, and may be split into an integer number of coding units.

According to an embodiment, the image decoding device 100 may split the current picture into a plurality of reference data units. According to an embodiment, the image decoding device 100 may split the plurality of reference data units, which are split from the current picture, by using splitting information about each reference data unit. The operation of splitting the reference data unit may correspond to a splitting operation using a quadtree structure.

According to an embodiment, the image decoding device 100 may previously determine the minimum size allowed for the reference data units included in the current picture. Accordingly, the image decoding device 100 may determine various reference data units having sizes equal to or greater than the minimum size, and may determine one or more coding units by using the block shape information and the split shape information with reference to the determined reference data unit.

Referring to FIG. 22, the image decoding device 100 may use a square reference coding unit 2200 or a non-square reference coding unit 2202. According to an embodiment, the shape and size of reference coding units may be determined based on various data units capable of including one or more reference coding units (e.g., sequences, pictures, slices, slice segments, largest coding units, or the like).

According to an embodiment, the receiver 210 of the image decoding device 100 may obtain, from a bitstream, at least one of reference coding unit shape information and reference coding unit size information with respect to each of the various data units. An operation of splitting the square reference coding unit 2200 into one or more coding units has been described above in relation to the operation of splitting the current coding unit 1000 of FIG. 10, and an operation of splitting the non-square reference coding unit 2202 into one or more coding units has been described above in relation to the operation of splitting the current coding unit 1100 or 1150 of FIG. 11. Thus, detailed descriptions thereof will not be provided herein.

According to an embodiment, the image decoding device 100 may use a PID for identifying the size and shape of reference coding units, to determine the size and shape of reference coding units according to some data units previously determined based on a predetermined condition. That is, the receiver 210 may obtain, from the bitstream, only the PID for identifying the size and shape of reference coding units with respect to each slice, slice segment, or largest coding unit which is a data unit satisfying a predetermined condition (e.g., a data unit having a size equal to or smaller than a slice) among the various data units (e.g., sequences, pictures, slices, slice segments, largest coding units, or the like). The image decoding device 100 may determine the size and shape of reference data units with respect to each data unit, which satisfies the predetermined condition, by using the PID. When the reference coding unit shape information and the reference coding unit size information are obtained and used from the bitstream according to each data unit having a relatively small size, efficiency of using the bitstream may not be high, and therefore, only the PID may be obtained and used instead of directly obtaining the reference coding unit shape information and the reference coding unit size information. In this case, at least one of the size and shape of reference coding units corresponding to the PID for identifying the size and shape of reference coding units may be previously determined. That is, the image decoding device 100 may determine at least one of the size and shape of reference coding units included in a data unit serving as a unit for obtaining the PID, by selecting the previously determined at least one of the size and shape of reference coding units based on the PID.

According to an embodiment, the image decoding device 100 may use one or more reference coding units included in a largest coding unit. That is, a largest coding unit split from a picture may include one or more reference coding units, and coding units may be determined by recursively splitting each reference coding unit. According to an embodiment, at least one of a width and height of the largest coding unit may be integer times at least one of the width and height of the reference coding units. According to an embodiment, the size of reference coding units may be obtained by splitting the largest coding unit n times based on a quadtree structure. That is, the image decoding device 100 may determine the reference coding units by splitting the largest coding unit n times based on a quadtree structure, and may split the reference coding unit based on at least one of the block shape information and the split shape information according to various embodiments.

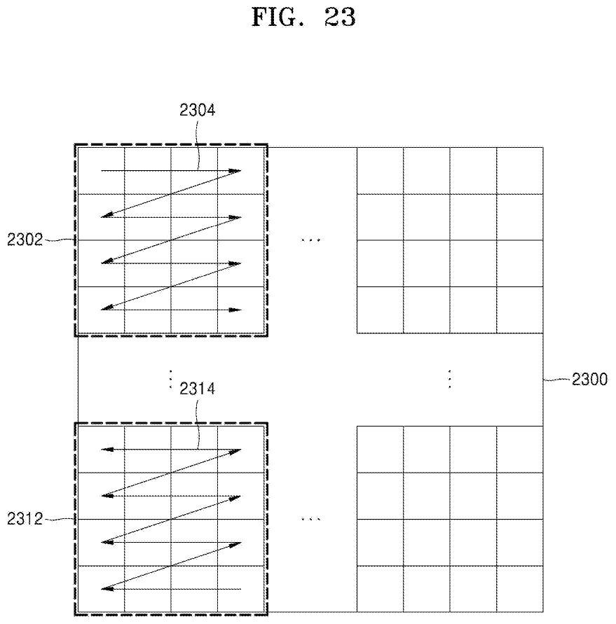

FIG. 23 illustrates a processing block serving as a unit for determining a determination order of reference coding units included in a picture 2300, according to an embodiment.

According to an embodiment, the image decoding device 100 may determine one or more processing blocks split from a picture. The processing block is a data unit including one or more reference coding units split from a picture, and the one or more reference coding units included in the processing block may be determined according to a specific order. That is, a determination order of one or more reference coding units determined in each processing block may correspond to one of various types of orders for determining reference coding units, and may vary depending on the processing block. The determination order of reference coding units, which is determined with respect to each processing block, may be one of various orders, e.g., raster scan order, Z-scan, N-scan, up-right diagonal scan, horizontal scan, and vertical scan, but is not limited to the above-mentioned scan orders.

According to an embodiment, the image decoding device 100 may obtain processing block size information and may determine the size of one or more processing blocks included in the picture. The image decoding device 100 may obtain the processing block size information from a bitstream and may determine the size of one or more processing blocks included in the picture. The size of processing blocks may be a predetermined size of data units, which is indicated by the processing block size information.

According to an embodiment, the receiver 210 of the image decoding device 100 may obtain the processing block size information from the bitstream according to each specific data unit. For example, the processing block size information may be obtained from the bitstream in a data unit such as an image, sequence, picture, slice, or slice segment. That is, the receiver 210 may obtain the processing block size information from the bitstream according to each of the various data units, and the image decoding device 100 may determine the size of one or more processing blocks, which are split from the picture, by using the obtained processing block size information. The size of the processing blocks may be integer times that of the reference coding units.

According to an embodiment, the image decoding device 100 may determine the size of processing blocks 2302 and 2312 included in the picture 2300. For example, the image decoding device 100 may determine the size of processing blocks based on the processing block size information obtained from the bitstream. Referring to FIG. 23, according to an embodiment, the image decoding device 100 may determine a width of the processing blocks 2302 and 2312 to be four times the width of the reference coding units, and may determine a height of the processing blocks 2302 and 2312 to be four times the height of the reference coding units. The image decoding device 100 may determine a determination order of one or more reference coding units in one or more processing blocks.

According to an embodiment, the image decoding device 100 may determine the processing blocks 2302 and 2312, which are included in the picture 2300, based on the size of processing blocks, and may determine a determination order of one or more reference coding units in the processing blocks 2302 and 2312. According to an embodiment, determination of reference coding units may include determination of the size of the reference coding units.

According to an embodiment, the image decoding device 100 may obtain, from the bitstream, determination order information of one or more reference coding units included in one or more processing blocks, and may determine a determination order with respect to one or more reference coding units based on the obtained determination order information. The determination order information may be defined as an order or direction for determining the reference coding units in the processing block. That is, the determination order of reference coding units may be independently determined with respect to each processing block.

According to an embodiment, the image decoding device 100 may obtain, from the bitstream, the determination order information of reference coding units according to each specific data unit. For example, the receiver 210 may obtain the determination order information of reference coding units from the bitstream according to each data unit such as an image, sequence, picture, slice, slice segment, or processing block. Because the determination order information of reference coding units indicates an order for determining reference coding units in a processing block, the determination order information may be obtained with respect to each specific data unit including an integer number of processing blocks.

According to an embodiment, the image decoding device 100 may determine one or more reference coding units based on the determined determination order.

According to an embodiment, the receiver 210 may obtain the determination order information of reference coding units from the bitstream as information related to the processing blocks 2302 and 2312, and the image decoding device 100 may determine a determination order of one or more reference coding units included in the processing blocks 2302 and 2312 and determine one or more reference coding units, which are included in the picture 2300, based on the determination order. Referring to FIG. 23, the image decoding device 100 may determine determination orders 2304 and 2314 of one or more reference coding units in the processing blocks 2302 and 2312, respectively. For example, when the determination order information of reference coding units is obtained with respect to each processing block, different types of the determination order information of reference coding units may be obtained for the processing blocks 2302 and 2312. When the determination order 2304 of reference coding units in the processing block 2302 is a raster scan order, reference coding units included in the processing block 2302 may be determined according to a raster scan order. On the contrary, when the determination order 2314 of reference coding units in the other processing block 2312 is a backward raster scan order, reference coding units included in the processing block 2312 may be determined according to the backward raster scan order.

According to an embodiment, the image decoding device 100 may decode the determined one or more reference coding units. The image decoding device 100 may decode an image, based on the reference coding units determined as described above. A method of decoding the reference coding units may include various image decoding methods.

According to an embodiment, the image decoding device 100 may obtain block shape information indicating the shape of a current coding unit or split shape information indicating a splitting method of the current coding unit, from the bitstream, and may use the obtained information. The block shape information or the split shape information may be included in the bitstream related to various data units. For example, the image decoding device 100 may use the block shape information or the split shape information included in a sequence parameter set, a picture parameter set, a video parameter set, a slice header, or a slice segment header. Furthermore, the image decoding device 100 may obtain, from the bitstream, syntax corresponding to the block shape information or the split shape information according to each largest coding unit, each reference coding unit, or each processing block, and may use the obtained syntax.

Various embodiments have been described above. It will be understood by those of ordinary skill in the art that the present disclosure may be embodied in many different forms without departing from essential features of the present disclosure. Therefore, the embodiments set forth herein should be considered in a descriptive sense only and not for purposes of limitation. The scope of the present disclosure is set forth in the claims rather than in the foregoing description, and all differences falling within a scope equivalent thereto should be construed as being included in the present disclosure.

The above-described embodiments of the present disclosure may be written as a computer executable program and implemented by a general-purpose digital computer which operates the program via a computer-readable recording medium. The computer-readable recording medium may include a storage medium such as a magnetic storage medium (e.g., a ROM, a floppy disk, a hard disk, etc.) and an optical recording medium (e.g., a CD-ROM, a DVD, etc.).

1. A method of decoding an image, the method comprising:
determining at least one coding unit for splitting a current frame that is one of at least one frame included in the image;
determining at least one prediction unit and at least one transformation unit included in a current coding unit that is one of the at least one coding unit;
obtaining residual sample values by inversely transforming a signal obtained from a bitstream;
obtaining a modified residual sample value by performing a rotation operation on the residual sample values included in a current transformation unit that is one of the at least one transformation unit; and
generating a reconstructed signal included in the current coding unit by using a predicted sample value included in the at least one prediction unit and the modified residual sample value,
wherein the rotation operation is performed by applying a rotation matrix kernel to coordinates including a first residual sample value and a second residual sample value that are included in the residual sample values.

2. The method of claim 1, wherein the obtaining of the modified residual sample value comprises obtaining a modified residual signal by performing the rotation operation, based on at least one of a position of a sample in the current transformation unit at which the rotation operation is started, an order in which the rotation operation is performed on the current transformation unit, and an angle by which the coordinates are shifted through the rotation operation.

3. The method of claim 2, wherein the obtaining of the modified residual sample value comprises:
determining at least one of the position of the sample at which the rotation operation is started, the order in which the rotation operation is performed, or the angle by which the coordinates are shifted, based on at least one of an intra-prediction mode performed with respect to the current coding unit, a partition mode for determining the at least one prediction unit, and a size of a block on which the rotation operation is performed; and
obtaining the modified residual signal by performing the rotation operation, based on at least one of the position, the order, or the angle.

4. The method of claim 3, wherein the determining of the at least one of the position of the sample at which the rotation operation is started, the order in which the rotation operation is performed, and the angle by which the coordinates are shifted comprises, when the intra-prediction mode performed with respect to the at least one prediction unit is a directional intra-prediction mode, determining at least one of the position of the sample at which the rotation operation is started, the order in which the rotation operation is performed, and the angle by which the coordinates are shifted, based on a prediction direction used in the directional intra-prediction mode.

5. The method of claim 4, wherein the determining of the at least one of the position of the sample at which the rotation operation is started, the order in which the rotation operation is performed, and the angle by which the coordinates are shifted comprises:
obtaining prediction mode information indicating the prediction direction from the bitstream; and
determining the order in which the rotation operation is performed according to one of a plurality of directions, based on the prediction mode information.

6. The method of claim 2, wherein the obtaining of the modified residual sample value comprises:
determining a maximum angle and a minimum angle by which the coordinates are shifted through the rotation operation;
determining a start position and an end position of the rotation operation in the current transformation unit; and
obtaining the modified residual sample value by performing the rotation operation on the coordinates, which are determined by the residual sample values at the start position and the end position, within a range of the maximum angle and the minimum angle.

7. The method of claim 6, wherein the obtaining of the modified residual sample value comprises obtaining the modified residual sample value by performing the rotation operation on the coordinates determined by the residual sample values at the start position and the end position, wherein the angle by which the coordinates are shifted is shifted at a certain ratio within the range of the maximum angle and the minimum angle.

8. The method of claim 1, wherein the obtaining of the modified residual sample value by performing the rotation operation comprises:
obtaining first information for each predetermined data unit from the bitstream, the first information indicating whether the rotation operation is to be performed when prediction is performed in a predetermined prediction mode; and
obtaining the modified residual sample value by performing the rotation operation on at least one transformation unit included in the predetermined data unit, based on the first information.

9. The method of claim 8, wherein the obtaining of the modified residual sample value comprises:
when the first information indicates that the rotation operation is to be performed, obtaining, from the bitstream, second information indicating a rotation-operation performance method;
determining a method of performing the rotation operation on the current coding unit, based on the second information; and
obtaining the modified residual sample value by performing the rotation operation on the current transformation unit according to the determined method,
wherein the determined method is configured based on at least one of the position of the sample at which the rotation operation is started, the order in which the rotation operation is performed, or the angle by which the coordinates are shifted.

10. The method of claim 8, wherein the obtaining of the first information comprises:
when a prediction mode, indicated by the first information, in which the rotation operation is to be performed is the same as a prediction mode performed with respect to the current coding unit, obtaining second information for each of the at least one coding unit from the bitstream, the second information indicating whether the rotation operation is to be performed on the current coding unit; and
performing the rotation operation on the current coding unit, based on the second information.

11. The method of claim 10, wherein the performing of the rotating operation on the current coding unit, based on the second information, comprises:
when the second information indicates that the rotation operation is to be performed on the current coding unit, obtaining third information for each of the at least one transformation unit from the bitstream, the third information indicating a method of performing the rotation operation on the current coding unit; and
obtaining the modified residual sample value by performing the rotation operation on the current coding unit according to the method indicated by the third information,
wherein the method is configured based on at least one of the position of the sample at which the rotation operation is started, the order in which the rotation operation is performed, or the angle by which the coordinates are shifted.

12. The method of claim 11, wherein, when the prediction mode, indicated by the first information, in which the rotation operation is to be performed is different from the prediction mode performed with respect to the current coding unit, the method comprises producing the reconstructed signal by using the residual sample value and the predicted sample value without obtaining the second information from the bitstream.

13. The method of claim 10, wherein the predetermined data unit comprises a largest coding unit, a slice, a slice segment, a picture, or a sequence, which includes the current coding unit.

14. A device for decoding an image, the device comprising:
a rotation operation unit configured to perform a rotation operation on residual sample values included in a current transformation unit, which is one of at least one transformation unit; and
a decoder configured to determine at least one coding unit for splitting a current frame that is one of at least one frame included in the image, determine at least one prediction unit and at least one transformation unit included in a current coding unit that is one of the at least one coding unit, obtaining residual sample values by inversely transforming a signal obtained from a bitstream, and generate a reconstructed signal included in the current coding unit by using a modified residual sample value obtained by performing a rotation operation and a predicted sample value included in the at least one prediction unit,
wherein the rotation operation is performed by applying a rotation matrix kernel to coordinates including a first residual sample value and a second residual sample value included in the residual sample values.

15. A computer-readable recording medium storing a computer program for performing the method of claim 1.
